(19) United States
(12) Patent Application Publication
(10) Pub. No.: US 2024/0292391 A1
(43) Pub. Date: Aug. 29, 2024

(54) SYSTEMS AND METHODS FOR COMBINED DATA AND SENSING IN ORTHOGONAL FREQUENCY DIVISION MULTIPLE ACCESS (OFDMA)

(71) Applicant: COGNITIVE SYSTEMS CORP., Waterloo (CA)

(72) Inventors: Chris BEG, Waterloo (CA); Mohammad OMER, Waterloo (CA)

(21) Appl. No.: 18/573,941

(22) PCT Filed: Jul. 8, 2022
(86) PCT No.: PCT/IB2022/056356

§ 371 Date: Dec. 22, 2023

Related U.S. Application Data
(60) Provisional application No. 63/233,014, filed on Aug. 13, 2021.
(60) Provisional application No. 63/220,254, filed on Jul. 9, 2021.

(51) Int. Cl. H04W 72/0453; G01S 7/00; G01S 13/00; G01S 13/04; G01S 13/87

(52) U.S. Cl. CPC H04W 72/0453; G01S 13/003; G01S 13/04; G01S 13/878; G01S 7/006

(57) ABSTRACT

Systems and methods for Wi-Fi sensing are provided. A method for Wi-Fi sensing carried out by a sensing receiver is described. A hybrid sensing-data trigger is created. The hybrid sensing-data trigger includes resource allocation fields corresponding to each of first sensing channel resource allocation to first sensing transmitter, second sensing channel resource allocation to second sensing transmitter, first data channel resource allocation to first station, and second data channel resource allocation to second station. The hybrid sensing-data trigger is transmitted to first sensing transmitter, second sensing transmitter, first station, and second station. Subsequently, first sensing transmission is received from first sensing transmitter, second sensing transmission is received from second sensing transmitter, first data transmission is received from first station, and second data transmission is received from second station. A first sensing measurement is generated based on first sensing transmission and second sensing measurement is generated based on second sensing transmission.

### TECHNICAL FIELD

The present disclosure generally relates to systems and methods for Wi-Fi sensing. In particular, the present disclosure relates to systems and methods for combined data and sensing in orthogonal frequency division multiple access (OFDMA).

### BACKGROUND OF THE DISCLOSURE

Motion detection systems have been used to detect movement, for example, of objects in a room or an outdoor area. In some example motion detection systems, infrared or optical sensors are used to detect the movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications.

The Wi-Fi sensing system may be implemented in a data carrying IEEE 802.11 network, where a primary function of the IEEE 802.11 network is data transfer. In an orthogonal frequency division multiple access (OFDMA) 802.11ax enabled system, an 802.11ax trigger frame may be used to allocate resource units (RUs) to a number of stations (STAs) for the purpose of data transfer. In certain situations, not all of the channel bandwidth is required for data transfer to and from STAs. For example, some of uplink bandwidth in transmission opportunity (TXOP) may not be used. This may result in inefficient use of the wireless channel.

### BRIEF SUMMARY OF THE DISCLOSURE

The present disclosure generally relates to systems and methods for Wi-Fi sensing. In particular, the present disclosure relates to systems and methods for combined data and sensing in orthogonal frequency division multiple access (OFDMA).

Systems and methods are provided for Wi-Fi sensing. In an example embodiment, a method configured for Wi-Fi sensing is described. The method is carried out by a sensing receiver including a transmitting antenna, a receiving antenna, and at least one processor configured to execute instructions. The method includes creating a hybrid sensing-data trigger, where the hybrid sensing-data trigger includes resource allocation fields corresponding to each of a first sensing channel resource allocation to a first sensing transmitter, a second sensing channel resource allocation to a second sensing transmitter, a first data channel resource allocation to a first station, and a second data channel resource allocation to a second station. The method further includes transmitting, via the transmitting antenna, the hybrid sensing-data trigger to the first sensing transmitter, the second sensing transmitter, the first station, and the second station, receiving, via the receiving antenna, a first sensing transmission from the first sensing transmitter and a second sensing transmission from the second sensing transmitter, receiving, via the receiving antenna, a first data transmission from the first station and a second data transmission from the second station, and generating, by the at least one processor, a first sensing measurement based on the first sensing transmission and a second sensing measurement based on the second sensing transmission.

In some embodiments, the method further includes determining, by the at least one processor, a first sensing requirement and a first sensing priority of the first sensing transmitter, determining, by the at least one processor, a second sensing requirement and a second sensing priority of the second sensing transmitter, determining, by the at least one processor, a first data requirement and a first data priority of the first station, and determining, by the at least one processor, a second data requirement and a second data priority of the second station, where the first sensing channel resource allocation, the second sensing channel resource allocation, the first data channel resource allocation and the second data channel resource allocation are determined according to the first sensing requirement and the first sensing priority, the second sensing requirement and the second sensing priority, the first data requirement and the first data priority, and the second data requirement and the second data priority.

In some embodiments, at least one of the first sensing channel resource allocation and the second sensing channel resource allocation includes a plurality of carrier tones from a OFDM modulation scheme.

In some embodiments, determining the first data requirement and the first data priority and the second data requirement and the second data priority is based on a first measure of fullness of a first transmission data buffer and a second measure of fullness of a second transmission data buffer.

In some embodiments, the first measure of fullness is received by the sensing receiver from the first station.

In some embodiments, the first measure of fullness is received by the sensing receiver in response to a request sent to the first station.

In some embodiments, determining the first data requirement and the first data priority and the second data requirement and the second data priority is based on a quality of service access category of the first transmission data buffer and a quality of service access category of the second transmission data buffer.

In some embodiments, determining the first sensing requirement and the first sensing priority and the second sensing requirement and the second priority is based on a first sensing mode of the first sensing transmitter and a second sensing mode of the second sensing transmitter.

In some embodiments, at least one of the first sensing mode and the second sensing mode is a scanning mode.

In some embodiments, at least one of the first sensing mode and the second sensing mode is a detection mode.

In some embodiments, determining at least one of the first sensing requirement and the first sensing priority, and the second sensing requirement and the second sensing priority is based on a total number of sensing transmitters.

In some embodiments, the first sensing channel resource allocation, the second sensing channel resource allocation, the first data channel resource allocation and the second data channel resource allocation are determined according to a pre-allocated split between data transmission and sensing bandwidth.

In some embodiments, the first sensing channel resource allocation, the second sensing channel resource allocation, the first data channel resource allocation and the second data channel resource allocation are determined to maximize resource usage.

In some embodiments, the hybrid sensing-data trigger includes a first requested transmission configuration field corresponding to the first sensing requirement and a second requested transmission configuration field corresponding to the second sensing requirement.

In some embodiments, generating the first sensing measurement based on the first sensing transmission includes the generation of a first time stamp indicating a time that the first sensing transmission was received by the sensing receiver.

In some embodiments, the hybrid sensing-data trigger is configured to cause transmission of the first sensing transmission from the first sensing transmitter according to the first sensing channel resource allocation, transmission of the second sensing transmission from the second sensing transmitter according to the second sensing channel resource allocation, transmission of the first data transmission from the first station according to the first data channel resource allocation, transmission of the second data transmission from the second station according to the second data channel resource allocation.

In some embodiments, the first sensing transmission and the first data transmission are received from a first device acting as the first sensing transmitter and the first station.

In another example embodiment, a system configured for Wi-Fi sensing is described which includes a sensing receiver including a transmitting antenna, a receiving antenna, and at least one processor configured to execute instructions. The instructions create a hybrid sensing-data trigger, where the hybrid sensing-data trigger includes resource allocation fields corresponding to each of a first sensing channel resource allocation to a first sensing transmitter, a second sensing channel resource allocation to a second sensing transmitter, a first data channel resource allocation to a first station, and a second data channel resource allocation to a second station; transmit, via the transmitting antenna, the hybrid sensing-data trigger to the first sensing transmitter, the second sensing transmitter, the first station, and the second station; receive, via the receiving antenna, a first sensing transmission from the first sensing transmitter and a second sensing transmission from the second sensing transmitter; receive, via the receiving antenna, a first data transmission from the first station and a second data transmission from the second station, and generate, by the at least one processor, a first sensing measurement based on the first sensing transmission and a second sensing measurement based on the second sensing transmission.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIGS. 2A and 2B are diagrams showing example wireless signals communicated between wireless communication devices;

FIGS. 3A and 3B are plots showing examples of channel responses computed from the wireless signals communicated between wireless communication devices in FIGS. 2A and 2B;

FIGS. 4A and 4B are diagrams showing example channel responses associated with motion of an object in distinct regions of a space;

FIGS. 4C and 4D are plots showing the example channel responses of FIGS. 4A and 4B overlaid on an example channel response associated with no motion occurring in the space;

FIG. 5 depicts an implementation of some of an architecture of an implementation of a system for Wi-Fi sensing, according to some embodiments;

FIG. 6 depicts an example of sensing requirements and data requirements for a network of an access point and a number of stations, according to some embodiments;

FIG. 7 depicts an example of prioritization for a network of an access point and a number of stations based on sensing requirements and data requirements, according to some embodiments;

FIGS. 8A to 8H depicts an example of hierarchy of fields within a hybrid sensing-data trigger, according to some embodiments;

FIG. 9 depicts an example of an Uplink Orthogonal Frequency Division Multiple Access (UL-OFDMA) based sensing and data transmissions transaction, according to some embodiments;

FIG. 10 depicts an example of an UL-OFDMA based sensing and data transmissions transaction using Aggregated MAC Protocol Data Unit (A-MPDU), according to some embodiments;

FIGS. 11A and 11B depict a flowchart for generating sensing measurements based on sensing transmissions, according to some embodiments; and

FIGS. 12A and 12B depict a flowchart for creating a hybrid sensing-data trigger, according to some embodiments.

### DETAILED DESCRIPTION

In some aspects of what is described here, a wireless sensing system can be used for a variety of wireless sensing applications by processing wireless signals (e.g., radio frequency signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access-point (AP) assumes the receiver role, and each Wi-Fi device (stations or nodes or peers) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference while others experience destructive interference.

The channel information for each of the communication links may be analyzed (e.g., by a hub device or other device in a wireless communication network, or a remote device communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered less frequently. In some implementations, when motion is present, for example, the wireless sensing system can increase the triggering rate to produce a time-series of measurements with finer time resolution. Controlling the variable measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or Extended Service Set (ESS) topology, multiple coordinating wireless access-points (APs) each provide a Basic Service Set (BSS) which may occupy different frequency bands and allow devices to transparently move between from one participating AP to another (e.g., mesh). For instance, within a home mesh network, Wi-Fi devices can connect to any of the APs, but typically select one with a good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP, but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area, in order to improve detection coverage, or to better localize motion within an area.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell-phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “transmission opportunity (TXOP)” may refer to a negotiated interval of time during which a particular quality of service (QOS) station (e.g., a sensing initiator or sensing transmitter) may have the right to initiate a frame exchange onto a wireless medium. A QOS access category (AC) of the transmission opportunity may be requested as part of a negotiation.

A term “Quality of Service (QOS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have differing transmission opportunity parameters defined for it.

A term “transmission parameters” may refer to a set of IEEE 802.11 PHY transmitter configuration parameters which are defined as part of transmission vector (TXVECTOR) corresponding to a specific PHY and which are configurable for each PHY-layer protocol data unit (PPDU) transmission.

A term “Null Data PPDU (NDP)” may refer to a PPDU that does not include data field. In an example, Null Data PPDU may be used for sensing transmission where it is the MAC header that includes the information required.

A term “Channel State Information (CSI)” may refer to properties of a communications channel that are known or measured by a technique of channel estimation. CSI may represent how wireless signals propagate from a transmitter to a receiver along multiple paths. CSI is typically a matrix of complex values representing the amplitude attenuation and phase shift of signals, which provides an estimation of a communications channel.

A term “resource unit (RU)” may refer to an allocation of orthogonal frequency division multiplexing (OFDM) channels which may be used to carry a modulated signal. An RU may include a variable number of carriers depending on the mode of the modem.

A term “uplink orthogonal frequency division multiple access (UL-OFDMA) sensing trigger message” may refer to a message from a sensing initiator to one or more sensing transmitters that causes the one or more sensing transmitters to generate a sensing transmission in a single TXOP using UL-OFDMA. The UL-OFMDA sensing trigger message may include data that instructs the one or more sensing transmitters how to form the sensing transmissions in response to the UL-OFMDA sensing trigger message.

A term “sensing transmitter” may refer to a device that sends a transmission (for example, PPDUs) used for sensing measurements (for example, channel state information) in a sensing session. In an example, a station is an example of a sensing transmitter. In some examples, an access point may also be a sensing transmitter for Wi-Fi sensing purposes in the example where a station acts as a sensing receiver.

A term “sensing receiver” may refer to a device that receives a transmission (for example, PPDUs) sent by a sensing transmitter and performs one or more sensing measurements (for example, CSI) in a sensing session. An access point is an example of a sensing receiver. In some examples, a station may also be a sensing receiver, for example in a mesh network scenario.

A term “sensing space” may refer to any physical space in which a Wi-Fi sensing system may operate.

A term “sensing initiator” may refer to a device that initiates a Wi-Fi sensing session.

A term “Wireless Local Area Network (WLAN) sensing session” may refer to a period during which objects in a physical space may be probed, detected and/or characterized. In an example, during a WLAN sensing session, several devices participate in, and thereby contribute to the generation of sensing measurements.

A term “sensing trigger message” may refer to a message sent from a sensing initiator or a sensing receiver to a sensing transmitter to initiate or trigger one or more sensing transmissions that may be used for sensing measurements. The sensing trigger message may be sent in a Trigger frame. The sensing trigger message may also be referred to a sensing initiation message.

A term “sensing response message” may refer to a message which is included within the sensing transmission from the sensing transmitter to the sensing receiver. The sensing transmission that includes the sensing response message is used by the sensing receiver to perform a sensing measurement.

A term “sensing transmission” may refer to a transmission made from the sensing transmitter to the sensing receiver which may be used to make a sensing measurement. In an example, a sensing transmission may also be referred to as wireless sensing signal or wireless signal.

A term “data transmission” may refer to a transmission made from a station to an access point which carries data and is not used for the purpose of sensing.

A term “sensing measurement” may refer to a measurement of a state of a channel between a transmitter device (for example, a sensing transmitter) and a receiver device (for example, a sensing receiver) derived from a sensing transmission. In an example, sensing measurement may also be referred to as channel response measurement.

A term “scanning mode” may refer to an operational mode having a purpose to identify motion or movement. The resolution in scanning mode is low and may not be sufficient for detecting fine motion. In an example, a Wi-Fi sensing system may operate in a scanning mode.

A term “detection mode” may refer to an operational mode having a purpose to detect motion or movement (for example, of an object that was previously identified) at a high resolution. In an example, a Wi-Fi sensing system may operate in a detection mode.

A term “sensing goal” may refer to a goal of a sensing activity at a time. A sensing goal is not static and may change at any time. In an example, the sensing goal may require sensing measurements of a specific type, a specific format, or a specific precision, resolution, or accuracy to be available to a sensing algorithm.

A term “sensing algorithm” may refer to a computational algorithm that achieves a sensing goal. The sensing algorithm may be executed on any device in a Wi-Fi sensing system.

A term “data transfer goal” may refer to a purpose associated with transfer of data between a station and an access point within a network of devices which both the station and the access point achieve or aim to achieve.

A term “time stamp” may refer to an indication of time which is applied to a sensing transmission or a sensing measurement.

A term “requested transmission configuration” may refer to requested transmission parameters of a sensing transmitter to be used when sending a sensing transmission.

A term “requested timing configuration” may refer to a set of timing requirements for sensing transmissions, for example, for a measurement campaign. In an example, the requested timing configuration may be periodic, semi-periodic, once, etc.

A term “steering matrix configuration” may refer to a matrix of complex values representing real and complex phase required to pre-condition antenna of a Radio Frequency (RF) transmission signal chain for each transmit signal. Application of the steering matrix configuration (for example, by a spatial mapper) enables beamforming and beam-steering.

A term “measurement time jitter” may refer to an inaccuracy which is introduced either when a time of measurement of a sensing measurement is inaccurate or when there is no time of measurement available.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes embodiments of systems and methods for Wi-Fi sensing. In particular, section B describes systems and methods for combined data and sensing in orthogonal frequency division multiple access (OFDMA).

### A. Wireless Communications System, Wireless Transmissions, and Sensing Measurements

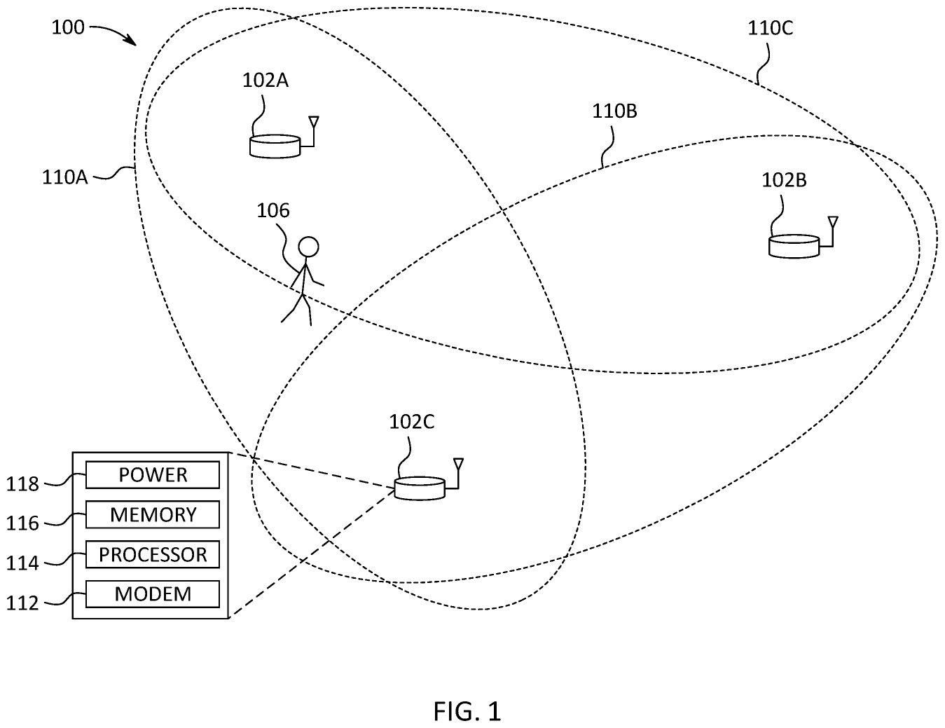

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi access points or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals, and sends the baseband signals to the baseband subsystem. The signals exchanged between the radio subsystem, and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

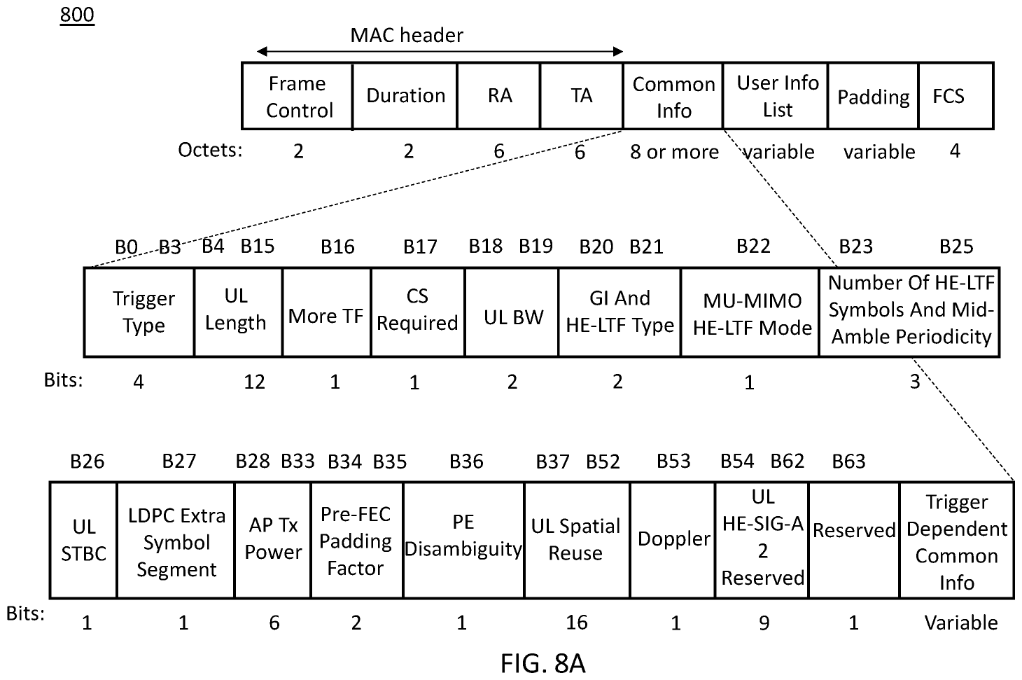

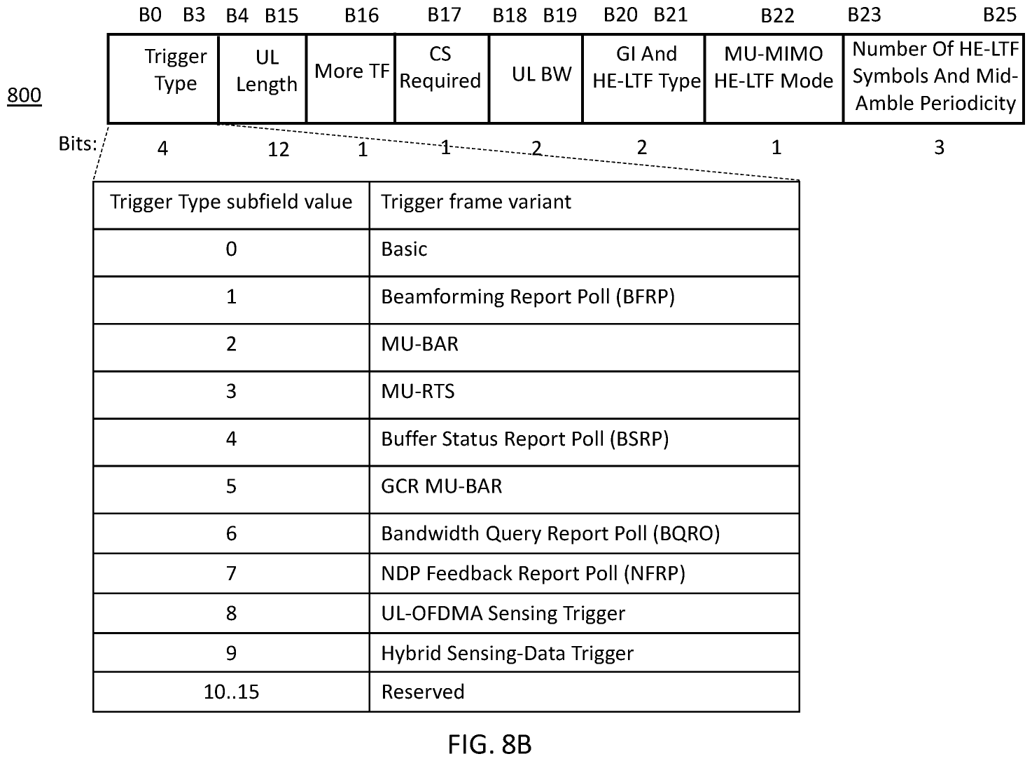

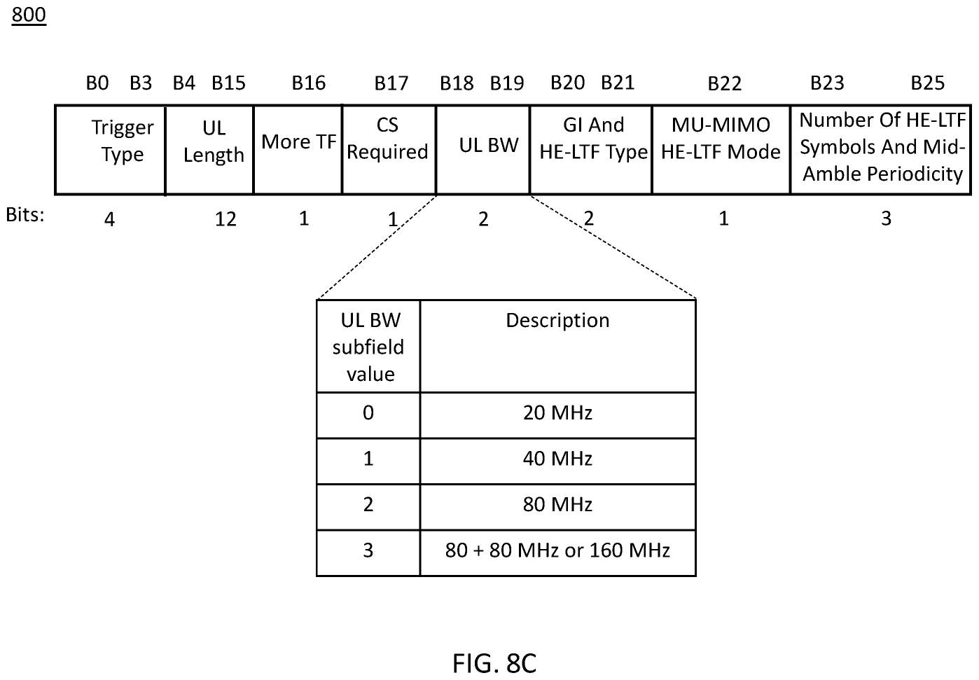

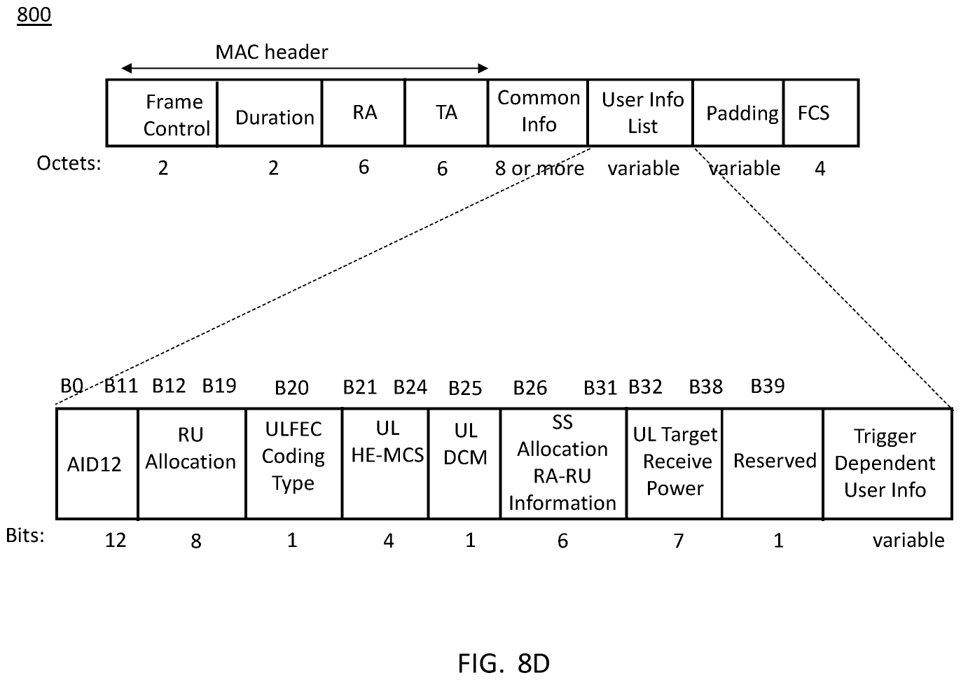

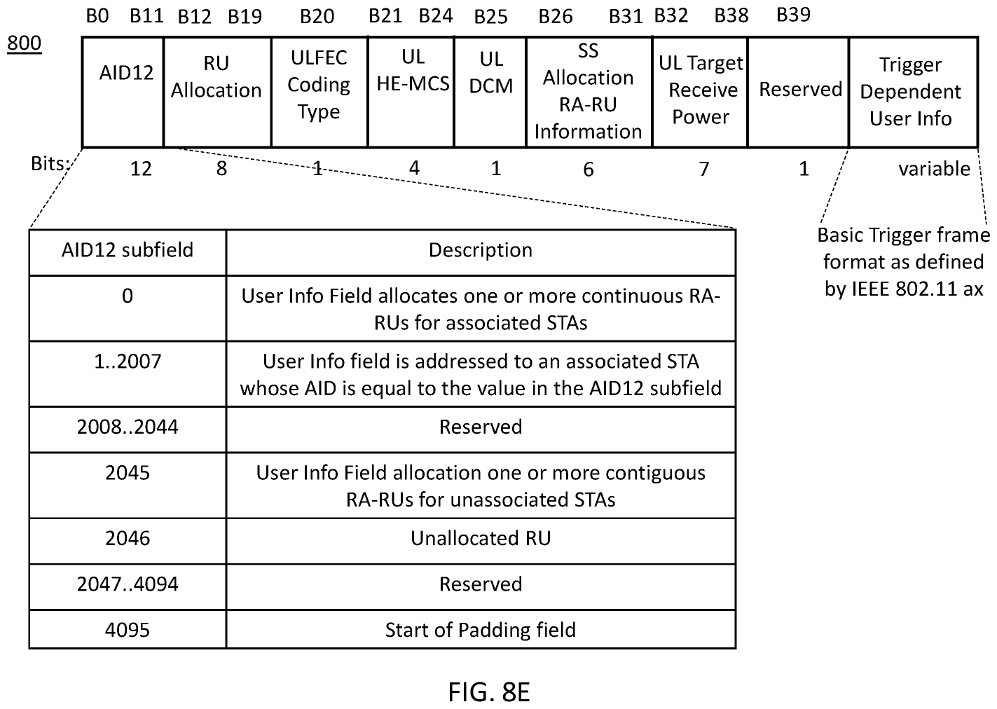

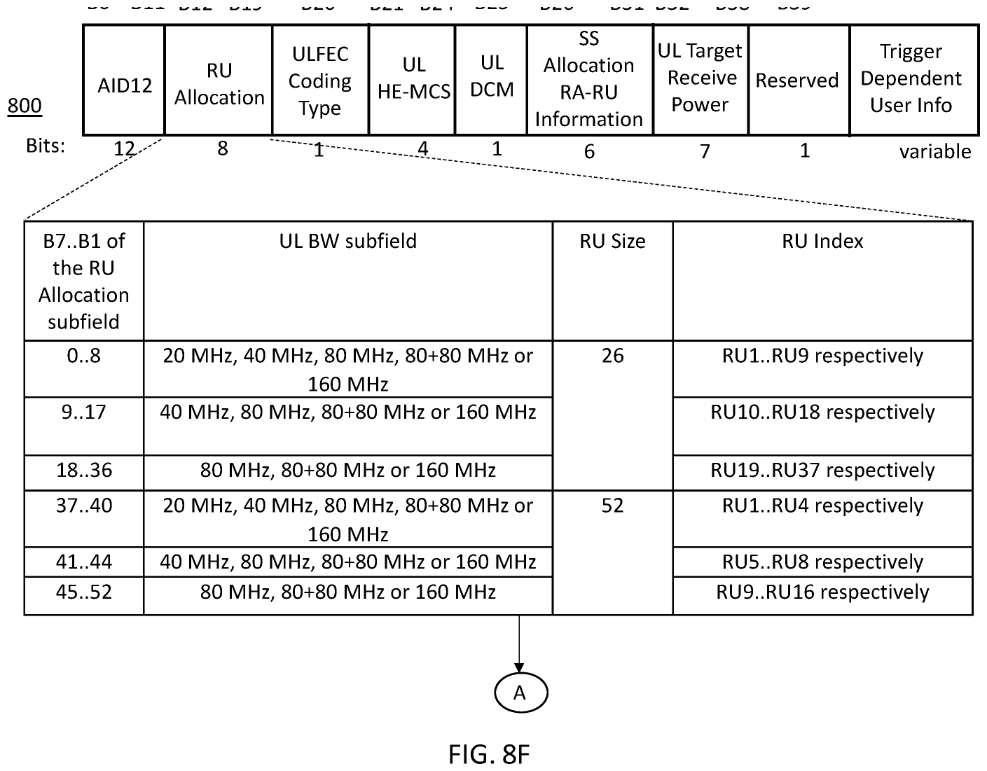

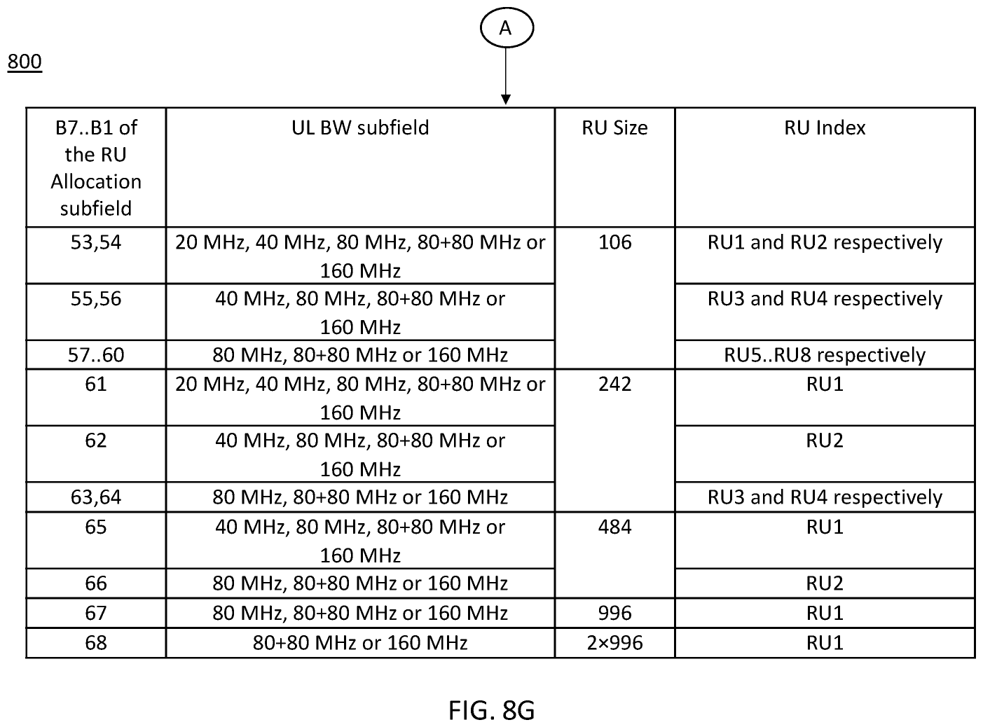

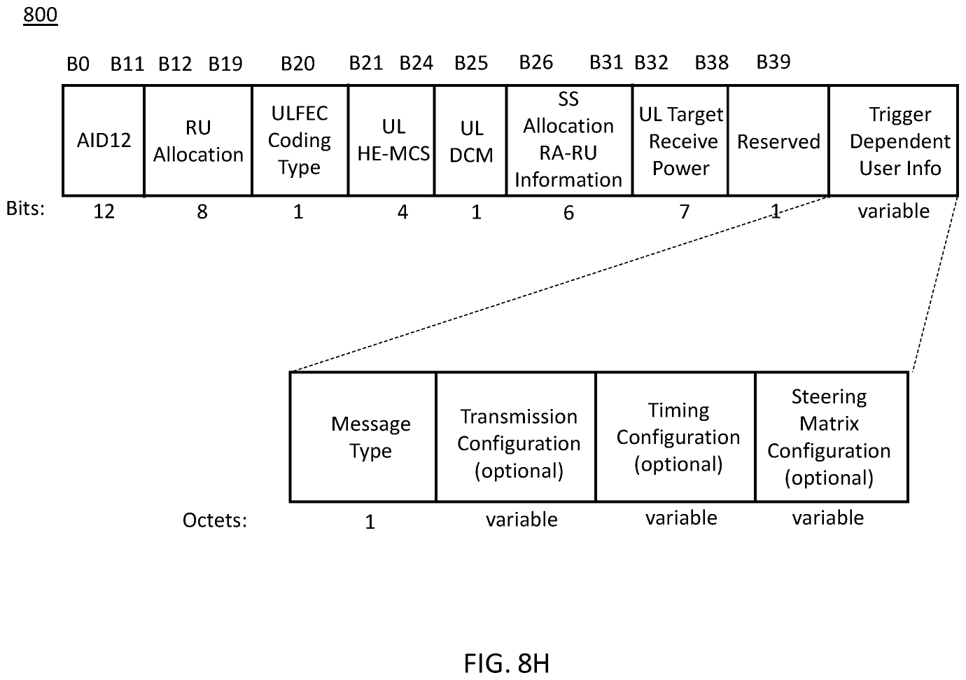

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIGS. 8A to 8H.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIGS. 8A to 8H, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly), an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

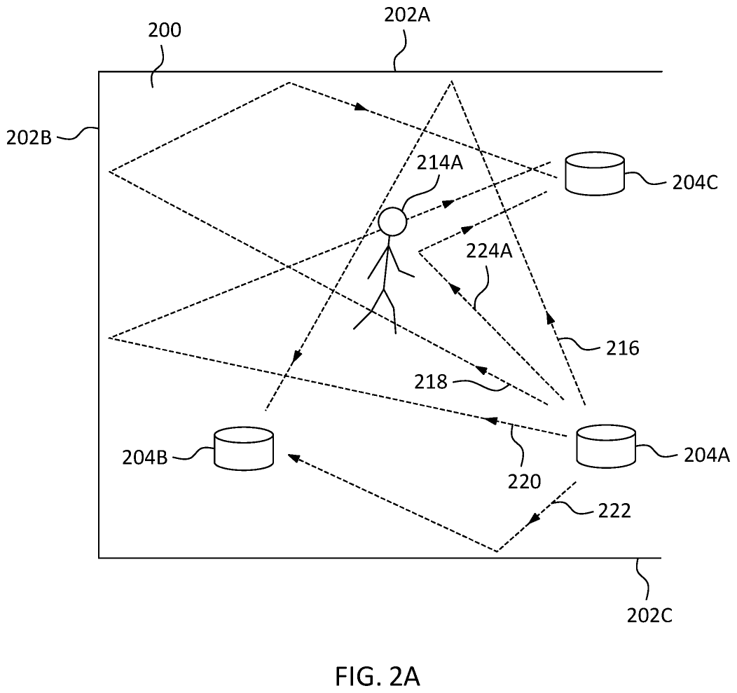

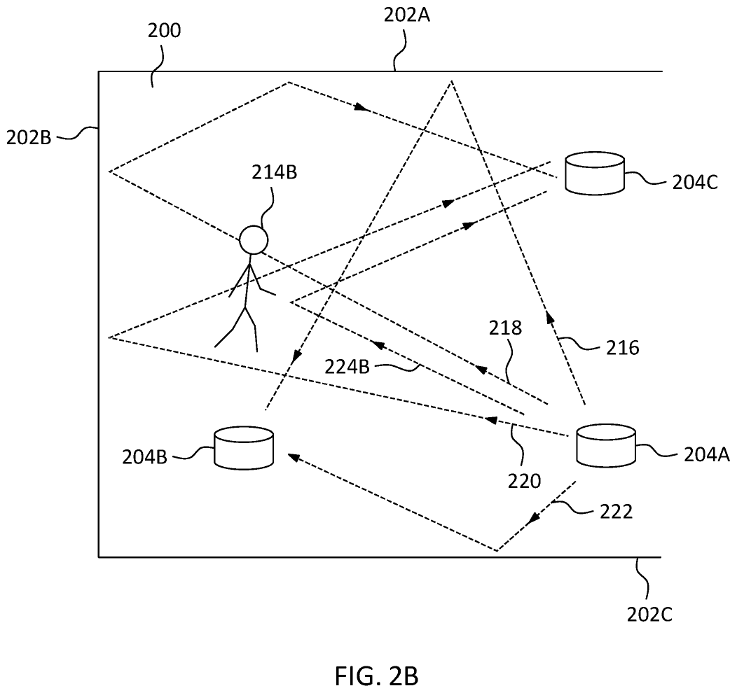

FIGS. 2A and 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIGS. 2A and 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIGS. 2A and 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIGS. 2A and 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIGS. 2A and 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIGS. 2A and 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIGS. 2A and 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIGS. 2A and 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal-will also change. A change in the received signal can be used to detect movement of an object.

Mathematically, a transmitted signal f(t) transmitted from the first wireless communication device 204A may be described according Equation (1):

$$f ( t ) = {\sum }_{n = - ∞}^{∞} {c}_{n} {e}^{j {ω}_{{n}^{t}}} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{{n}^{t}}} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component on indicates a relative magnitude and phase offset of the received signal at that frequency component ωₙ. When an object moves in the space, the complex value Hₙ changes due to the channel response α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{c h} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal R_{ef} can be modified with candidate channel responses (h_{ch}), and then a maximum likelihood approach can be used to select the candidate channel which gives best match to the received signal (R_{cvd}). In some cases, an estimated received signal (\hat{R}_{cvd}) is obtained from the convolution of the reference signal (R_{ef}) with the candidate channel responses (h_{ch}), and then the channel coefficients of the channel response (h_{ch}) are varied to minimize the squared error of the estimated received signal (\hat{R}_{cvd}). This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{c h}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

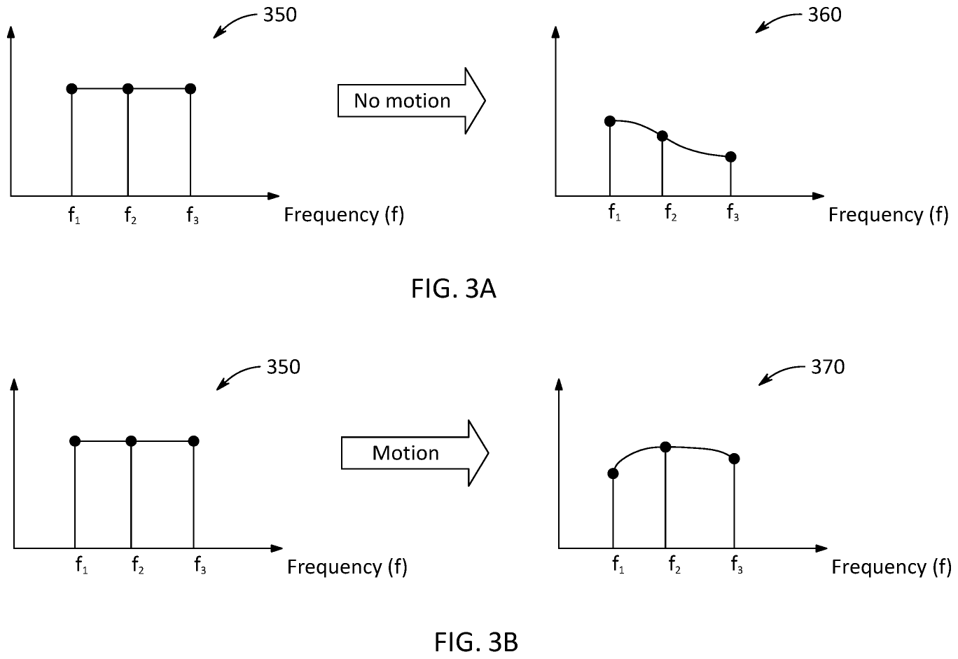

FIGS. 3A-3B are plots showing examples of channel responses 360, 370 computed from the wireless signals communicated between wireless communication devices 204A, 204B, 204C in FIGS. 2A-2B. FIGS. 3A-3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIGS. 3A-3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A look different from the transmitted signal. In this example, where the transmitted signal has a flat frequency profile, the received signal represents the channel response of space 200. As shown in FIGS. 3A-3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

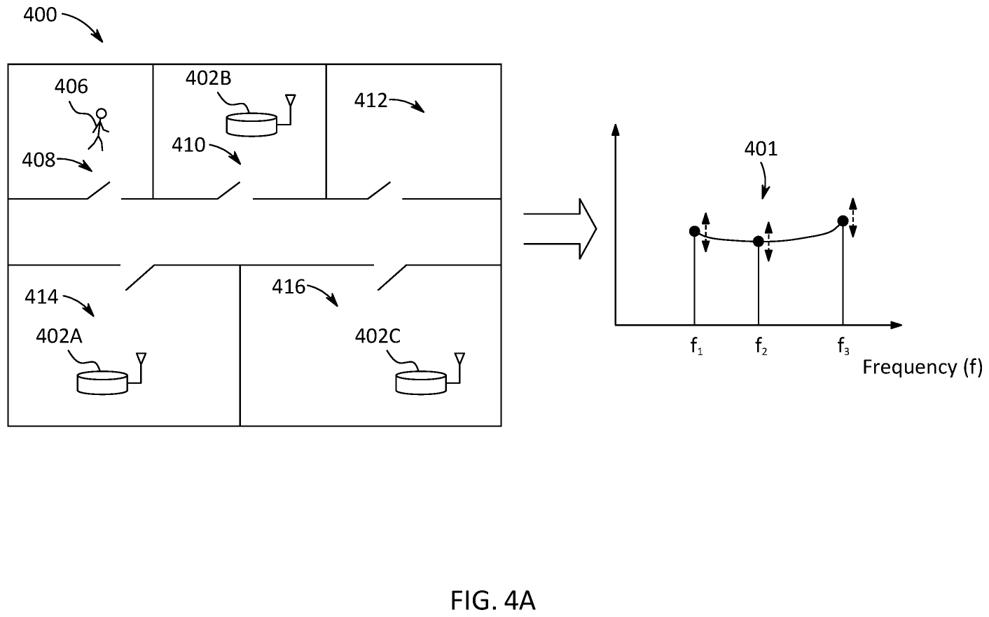

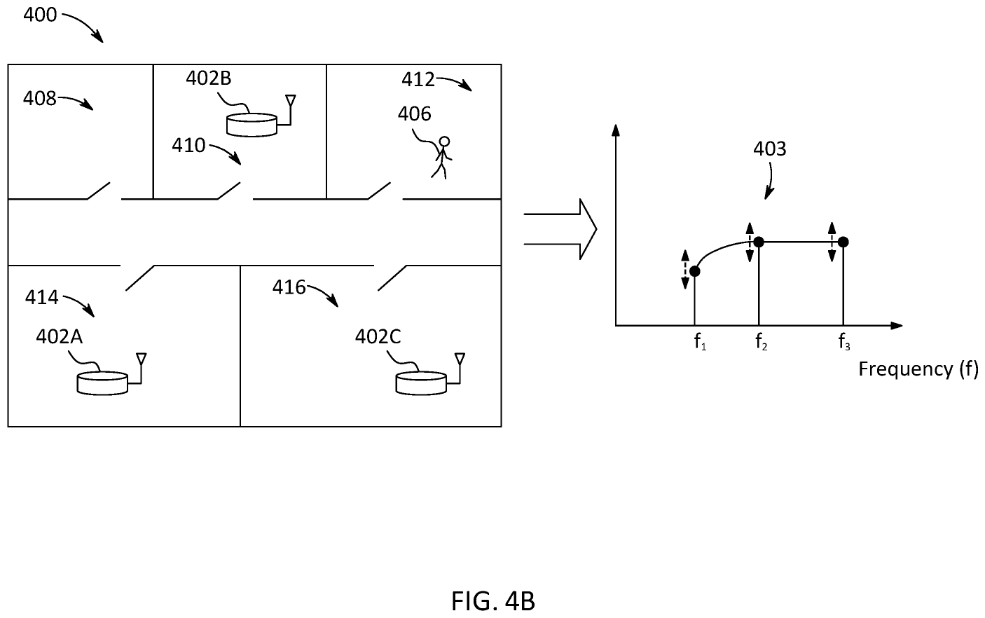

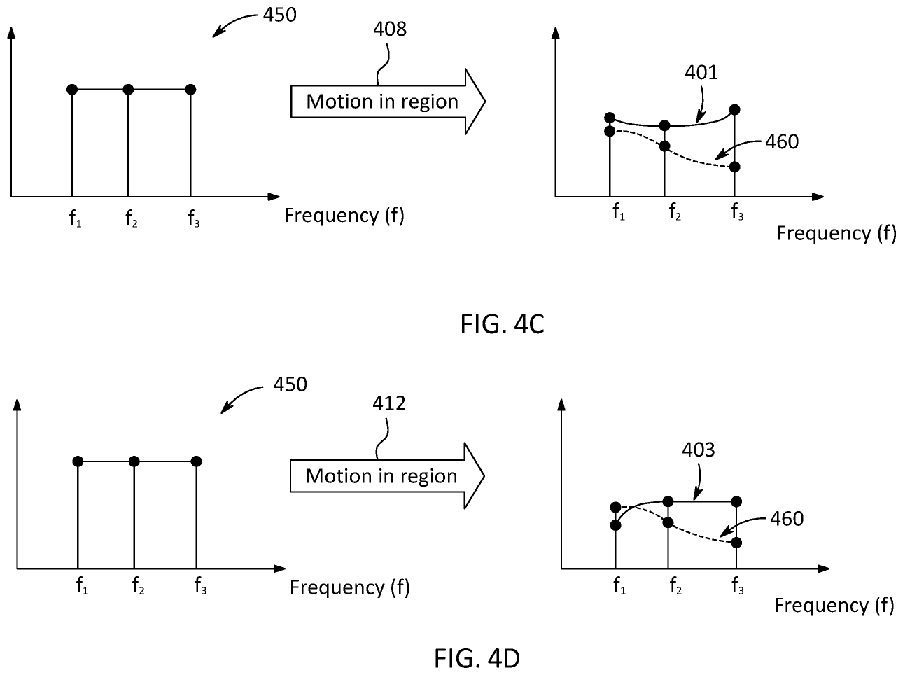

FIGS. 4A-4B are diagrams showing example channel responses 401, 403 associated with motion of object 406 in distinct regions 408, 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIGS. 4A-4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 106, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component f₁, f₂, and f₃. For example, the motion probe signals may have a frequency response similar to frequency domain representation 350 shown in FIGS. 3A-3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIGS. 4C-4D are plots showing channel responses 401, 403 of FIGS. 4A-4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained AI model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIGS. 4C-4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. In other words, a channel response has been formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIGS. 4A-4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Systems and Methods for Combined Data and Sensing in Orthogonal Frequency Division Multiple Access (OFDMA)

The present disclosure generally relates to systems and methods for Wi-Fi sensing. In particular, the present disclosure relates to systems and methods for combined data and sensing in orthogonal frequency division multiple access (OFDMA).

The present disclosure describes a scheduling algorithm that considers both a data transfer goal (or an uplink data transfer goal) of a plurality of stations in an IEEE 802.11 network and a sensing goal of a Wi-Fi sensing system and allocates channel resources (interchangeably referred to as resource units (RUS)) to the plurality of stations to achieve or to partly achieve both the data transfer goal and the sensing goal. In an example, the data transfer goal may depend on requirements at a moment in time and may not be the same for all stations in the network. Examples of a data transfer goal include high throughput and low latency. In an example, the data transfer goal and the sensing goal may be dynamic goals and may evolve and change with time.

According to an implementation, the scheduling algorithm may be used to determine a manner in which a transmission opportunity (TXOP) may be allocated to the plurality of stations to support both the data transfer goal of each station and the sensing goal of the Wi-Fi sensing system. In scenarios where both data transmissions and sensing transmissions are required in a same TXOP (i.e., a single TXOP), some of the plurality of stations may participate in data transmissions while other stations may participate in sensing transmissions. According to an implementation, an aggregation technique may be used to combine a data transmission with information which may allow the data transmission to be used as a sensing transmission.

The system and method of the present disclosure leverage an access point (for example, a sensing receiver) which is compatible with IEEE 802.11ax or later standards. In an implementation, the access point may be configured to request the plurality of stations associated with the access point to transmit to the access point using Uplink OFDMA (UL-OFDMA) by allocating bandwidth to participating stations. The implementation allows the access point to control the scheduling of uplink transmissions (i.e., from the stations to the access point) with the aim of achieving the data transfer goal and the sensing goal. In an implementation, the scheduling algorithm may run on the access point, allowing the access point to secure a TXOP, to determine which stations should be allocated bandwidth in the TXOP, and to determine how much bandwidth each station should be allocated to achieve each station's data transfer goal.

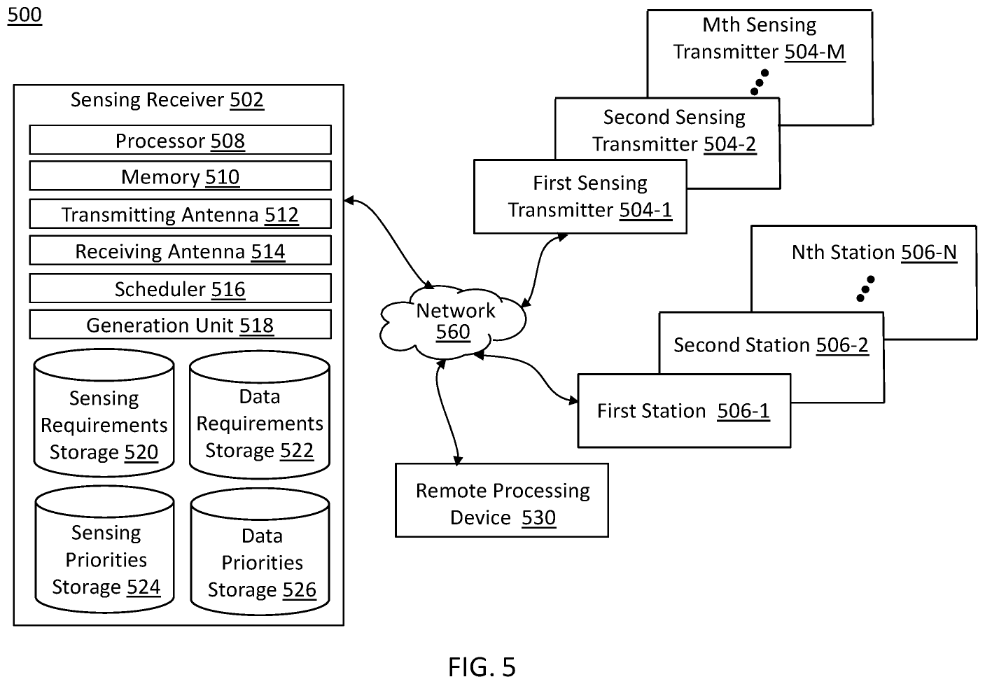

FIG. 5 depicts an implementation of some of an architecture of an implementation of system 500 for Wi-Fi sensing, according to some embodiments.

System 500 may include sensing receiver 502, plurality of sensing transmitters 504-(1-M), plurality of stations 506-(1-N), and network 560 enabling communication between the system components for information exchange. In an example implementation, plurality of sensing transmitters 504-(1-M) may include at least first sensing transmitter 504-1 and second sensing transmitter 504-2, and plurality of stations 506-(1-N) may include at least first station 506-1 and second station 506-2. System 500 may be an example or instance of wireless communication system 100 and network 560 may be an example or instance of wireless network or cellular network, details of which are provided with reference to FIG. 1 and its accompanying description.

For the ease of explanation and understanding, the description hereinafter is provided with reference to first sensing transmitter 504-1, second sensing transmitter 504-2, first station 506-1, and second station 506-2, however the description is equally applicable to remaining sensing transmitters 504-(3-M) and remaining stations 506-(3-N).

According to an embodiment, sensing receiver 502 may be configured to receive a sensing transmission (for example, from each of first sensing transmitter 504-1 and second sensing transmitter 504-2), and perform one or more measurements (for example, CSI) useful for Wi-Fi sensing. These measurements may be known as sensing measurements. The sensing measurements may be processed to achieve a sensing goal of system 500. Also, sensing receiver 502 may be configured to receive a data transmission (for example, from each of first station 506-1 and second station 506-2) and process the data transmission to achieve a data transfer goal of each of first station 506-1 and second station 506-2. In an embodiment, sensing receiver 502 may be an access point. In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIGS. 2A and 2B. Further, sensing receiver 502 may be implemented by a device, such as wireless communication device 402 shown in FIGS. 4A and 4B. In an implementation, sensing receiver 502 may coordinate and control communication among plurality of sensing transmitters 504-(1-M) and plurality of stations 506-(1-N). According to an implementation, sensing receiver 502 may be enabled to control a measurement campaign to ensure that required sensing transmissions are made at a required time and to ensure an accurate determination of sensing measurement. In some embodiments, sensing receiver 502 may process sensing measurements to achieve the sensing goal of system 500. In some embodiments, sensing receiver 502 may be configured to transmit sensing measurements to remote processing device 530 and remote processing device 530 may be configured to process the sensing measurements to achieve the sensing goal of system 500.

Referring again to FIG. 5, in some embodiments, each of plurality of sensing transmitters 504-(1-M) may form a part of a Basic Service Set (BSS) and may be configured to send a sensing transmission to sensing receiver 502 based on which, one or more sensing measurements (for example, CSI) may be performed for Wi-Fi sensing. In an embodiment, each of plurality of sensing transmitters 504-(1-M) may be a station. In an example implementation, when a station makes a sensing transmission, it may be referred to as a sensing transmitter. According to an implementation, each of plurality of sensing transmitters 504-(1-M) may be implemented by a device, such as wireless communication device 102 shown in FIG. 1. In some implementations, each of plurality of sensing transmitters 504-(1-M) may be implemented by a device, such as wireless communication device 204 shown in FIGS. 2A and 2B. Further, each of plurality of sensing transmitters 504-(1-M) may be implemented by a device, such as wireless communication device 402 shown in FIGS. 4A and 4B. In some implementations, communication between sensing receiver 502 and each of plurality of sensing transmitters 504-(1-M) may happen via Station Management Entity (SME) and MAC Layer Management Entity (MLME) protocols.

According to some embodiments, each of plurality of stations 506-(1-N) may form a part of BSS and may be configured to send a data transmission to sensing receiver 502. According to an implementation, each of plurality of stations 506-(1-N) may be implemented by a device, such as wireless communication device 102 shown in FIG. 1. In some implementations, each of plurality of stations 506-(1-N) may be implemented by a device, such as wireless communication device 204 shown in FIGS. 2A and 2B. Further, each of plurality of stations 506-(1-N) may be implemented by a device, such as wireless communication device 402 shown in FIGS. 4A and 4B. In some implementations, communication between sensing receiver 502 and each of plurality of stations 506-(1-N) may happen via Station Management Entity (SME) and MAC Layer Management Entity (MLME) protocols.

Referring to FIG. 5, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna(s) 512, receiving antenna(s) 514, scheduler 516, and generation unit 518. In some embodiments, an antenna may be used to both transmit and receive signals in a half-duplex format. When the antenna is transmitting, it may be referred to as transmitting antenna 512 and when the antenna is receiving, it may be referred to as receiving antenna 514. It is understood by a person of normal skill in the art that the same antenna may be transmitting antenna 512 in some instances and receiving antenna 514 in other instances. In the case of an antenna array, one or more antenna elements may be used to transmit or receive a signal, for example, in a beamforming environment. In some examples, a group of antenna elements used to transmit a composite signal may be referred to as transmitting antenna 512, and a group of antenna elements used to receive a composite signal may be referred to as receiving antenna 514. In some examples, each antenna is equipped with its own transmission and receive paths, which may be alternately switched to connect to the antenna depending on whether the antenna is operating as transmitting antenna 512 or receiving antenna 514.

In an implementation, scheduler 516 and generation unit 518 may be coupled to processor 508 and memory 510. In some embodiments, scheduler 516 and generation unit 518 amongst other units, may include routines, programs, objects, components, data structures, etc., which may perform particular tasks or implement particular abstract data types. Scheduler 516 and generation unit 518 may also be implemented as, signal processor(s), state machine(s), logic circuitries, and/or any other device or component that manipulate signals based on operational instructions.

In some embodiments, scheduler 516 and generation unit 518 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, scheduler 516 and generation unit 518 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 510.

According to some implementations, scheduler 516 may include/execute a scheduling algorithm. In some embodiments, scheduler 516 may have multiple modes of operation or states that it executes during Wi-Fi sensing. According to an implementation, scheduler 516 may be responsible for making propagation channel resource decisions based on sensing requirements and data requirements. In an implementation, generation unit 518 may be responsible for receiving sensing transmissions and associated transmission parameters, calculating sensing measurements, and processing sensing measurements to fulfill a sensing goal. In some implementations, generation unit 518 may be responsible for receiving data transmissions and processing data transmissions to fulfill a data transfer goal. In some implementations, generation unit 518 may be configured to transmit sensing measurements to remote processing device 530 for further processing. In an implementation, generation unit 518 may be configured to cause at least one transmitting antenna of transmitting antenna(s) 512 to transmit messages to each of plurality of sensing transmitters 504-(1-M) and each of plurality of stations 506-(1-N). Further, generation unit 518 may be configured to receive, via at least one receiving antenna of receiving antennas(s) 514, messages from each of plurality of sensing transmitters 504-(1-M) and each of plurality of stations 506-(1-N).

In some embodiments, sensing receiver 502 may include sensing requirements storage 520, data requirements storage 522, sensing priorities storage 524, and data priorities storage 526. In an implementation, sensing requirements storage 520 may store sensing requirements of each of plurality of sensing transmitters 504-(1-M). According to an implementation, data requirements storage 522 may store data requirements of each of plurality of stations 506-(1-N). In an implementation, sensing priorities storage 524 may store a sensing priority of each of plurality of sensing transmitters 504-(1-M). Examples of the sensing priority include “MUST”, “HIGH”, “LOW”, “NONE”, and “BEST EFFORT”. According to an implementation, data priorities storage 526 may store a data priority of each of plurality of stations 506-(1-N). Examples of the data priority include “MUST”, “HIGH”, “LOW”, “NONE”, and “BEST EFFORT”. Information related to the sensing requirements of plurality of sensing transmitters 504-(1-M) stored in sensing requirements storage 520, information related to the data requirements of plurality of stations 506-(1-N) stored in data requirements storage 522, information related to the sensing priorities of plurality of sensing transmitters 504-(1-M) stored in sensing priorities storage 524, and information related to the data priorities of plurality of stations 506-(1-N) stored in data priorities storage 526 may be periodically or dynamically updated as required. In an implementation, sensing requirements storage 520, data requirements storage 522, sensing priorities storage 524, and data priorities storage 526 may include any type or form of storage, such as a database or a file system or coupled to memory 510.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax adopted OFDMA, which allows sensing receiver 502 to simultaneously transmit data to all participating devices, such as plurality of sensing transmitters 504-(1-M) and plurality of stations 506-(1-N), and vice versa using a single TXOP. According to an implementation, system 500 may be an OFDMA 802.11ax enabled system.

Referring again to FIG. 5, in an implementation, sensing receiver 502 may initiate a measurement campaign. According to an implementation, scheduler 516 may determine a first sensing requirement and a first sensing priority of first sensing transmitter 504-1, and a second sensing requirement and a second sensing priority of second sensing transmitter 504-2. In an example, a sensing requirement may include a broad type of a sensing transmission. In some examples, the sensing requirement may include detailed requirements. In an example, the broad type sensing transmission may include information related to a type of sensing mode. The sensing mode may be one of a scanning mode and a detection mode. Further, the detailed requirements may include information related to sensing bandwidth. Examples of detailed requirements include “bandwidth of 26 tones”, “bandwidth of 484 tones” and “HE-LTF as a training field”. In an implementation, scheduler 516 may map the broad type of sensing transmission uniquely to detailed requirements. In some implementations, scheduler 516 may interpret the broad type of sensing transmission to map to a range of detailed requirements.

According to an implementation, scheduler 516 may determine the first sensing requirement and the first sensing priority of first sensing transmitter 504-1 based on a first sensing mode of operation of first sensing transmitter 504-1. Further, scheduler 516 may determine the second sensing requirement and the second sensing priority of second sensing transmitter 504-2 based on a second sensing mode of operation of second sensing transmitter 504-2. In an example, at least one of the first sensing mode and the second sensing mode may be a scanning mode. In some examples, at least one of the first sensing mode and the second sensing mode may be a detection mode. According to some implementations, scheduler 516 may determine at least one of the first sensing requirement and the first sensing priority, and the second sensing requirement and the second sensing priority based on a total number of sensing transmitters. According to an implementation, scheduler 516 may store the first sensing requirement of first sensing transmitter 504-1 and the second sensing requirement of second sensing transmitter 504-2 in sensing requirements storage 520, and the first sensing priority of first sensing transmitter 504-1 and the second sensing priority of second sensing transmitter 504-2 in sensing priorities storage 524 for future use.

According to an implementation, scheduler 516 may prioritize a sensing transmission from a sensing transmitter based on whether it is part of a scanning mode operation or a detection mode operation. The sensing transmission which is the part of the scanning mode operation may be referred to as the scanning mode sensing transmission hereinafter, and the sensing transmission which is the part of the detection mode operation may be referred to as the detection mode sensing transmission hereinafter. In an example implementation, a detection mode sensing transmission may be assigned a higher sensing priority in comparison to a scanning mode sensing transmission when uplink bandwidth is allocated to the sensing transmission. In an example implementation, scheduler 516 may select a subset of sensing transmissions to allocate uplink bandwidth in a way that maximizes the use of the available uplink bandwidth. In an example, if sensing transmissions are requested for a detection mode for two sensing transmitters, but there may be only sufficient bandwidth to allocate one of the two sensing transmitters (with some bandwidth left over but not enough to allocate to the other sensing transmitter), then scheduler 516 may allocate a portion of uplink bandwidth to the detection mode sensing transmissions, and then allocate unused uplink bandwidth or the remainder of the uplink bandwidth to the sensing mode sensing transmissions. In some examples, scheduler 516 may prioritize the sensing transmissions that scheduler 516 may want to receive and allocate uplink bandwidth according to the prioritization.

According to an example, multiple parallel scanning mode sensing transmissions may be assigned higher sensing priorities in comparison to a single detection mode sensing transmission when a number of scanning mode sensing transmissions that may be scheduled instead of the single detection mode sensing transmission is greater than a predefined sensing threshold. In an example, the predefined sensing threshold may be fixed. In some examples, the predefined sensing threshold may be configurable. In an example, a value of the predefined sensing threshold may be four (4). According to an example, if five (5) parallel scanning mode sensing transmissions can be made instead of (or versus) a single detection mode sensing transmission, then a sensing priority of the five scanning mode sensing transmission may be set to be higher than the single detection mode sensing transmission. In some examples, if only four (4) parallel scanning mode sensing transmissions can be made instead of (or versus) a single detection mode sensing transmission, then the sensing priority of the detection mode sensing transmission may be set to be higher than the four (4) scanning mode sensing transmissions.

According to some implementations, scheduler 516 may prioritize the sensing transmission based on the number of channel resources that it requires. In an example, multiple sensing transmissions may be prioritized to accommodate the greatest number of sensing transmissions within an available number of channel resources. In the example, scheduler 516 may assign a sensing priority as “HIGH” to sensing transmissions which are accommodated. In some examples, scheduler 516 may assign a sensing priority as “LOW” or a sensing priority as “NONE” to sensing transmissions which are not accommodated.

According to an implementation, scheduler 516 may determine a first data requirement and a first data priority of first station 506-1, and a second data requirement and a second data priority of second station 506-2. In example, a data requirement may include an amount of uplink data that a station has kept ready to be sent to an access point. In an example, the access point may be sensing receiver 502. The amount of uplink data may be reflected by an amount of data stored in a data buffer. For example, the amount of uplink data may be an amount of data reported by a Buffer Status Report (BSR) message. In some examples, the amount of uplink data may be derived from QoS control data reporting queued data per QoS Access Category (AC).

In an implementation, scheduler 516 may determine the first data requirement and the first data priority based on a first measure of fullness of a first transmission data buffer. According to an implementation, scheduler 516 may receive the first measure of fullness from first station 506-1. In some implementations, scheduler 516 may receive the first measure of fullness from first station 506-1 in response to a request sent to first station 506-1. According to an implementation, scheduler 516 may determine the second data requirement and the second data priority based on a second measure of fullness of a second transmission data buffer. In an implementation, scheduler 516 may receive the second measure of fullness from second station 506-2. In some implementations, scheduler 516 may receive the second measure of fullness from second station 506-2 in response to a request sent to second station 506-2. According to some implementations, scheduler 516 may determine the first data requirement and the first data priority based on a QoS AC of the first transmission data buffer, and the second data requirement and the second data priority based on a QoS AC of the second transmission data buffer. In an implementation, scheduler 516 may store the first data requirement of first station 506-1 and the second data requirement of second station 506-2 in data requirements storage 522, and the first data priority of first station 506-1 and the second data priority of second station 506-2 in data priorities storage

In an implementation, scheduler 516 may prioritize a data transmission from a station based on a utilization of a data buffer on the station. According to an example, if utilization of the data buffer is high in comparison to a predefined data threshold, then the data transmission may be assigned a higher data priority than if the utilization of the data buffer is low. In an example, the predefined data threshold may be fixed. In some examples, the predefined data threshold may be configurable. In an implementation, a level of utilization may be mapped to a level of data priority. In an example, if utilization is greater than 90 percent, scheduler 516 may assign a data priority as “MUST” to the data transmission. In some examples, if utilization is in between 75 percent to 90 percent, scheduler 516 may assign a data priority as “HIGH” to the data transmission. In some examples, if utilization is in between 50 percent to 75 percent, scheduler 516 may assign a data priority as “NONE” to the data transmission. According to some implementations, the data transmission may be prioritized based on a QoS AC. In an example, scheduler 516 may assign a data priority as “HIGH” to AC_VO and AC_VI. In some examples, scheduler 516 may assign a data priority as “LOW” to AC_BK and AC_BE.

According to an implementation, scheduler 516 may determine sensing requirements and sensing priorities for all sensing transmissions which are pending in the uplink direction (for example, from first sensing transmitter 504-1 and second sensing transmitter 504-2 to sensing receiver 502) and data requirements and data priorities of all data transmissions which are pending in the uplink direction (for example, from first station 506-1 and second station 506-2 to sensing receiver 502). According to an implementation, scheduler 516 may secure a single TXOP which may be allocated to a combination of pending sensing transmissions and data transmissions. In an example, scheduler 516 may allocate bandwidth across the TXOP to both the sensing transmissions and the data transmissions.

In an implementation, scheduler 516 may determine the priority for queued or pending sensing transmissions and data transmissions based a mode of operation in which scheduler 516 is running. Examples of modes of operation include a “global priority to data” mode, a “global priority to sensing” mode, an “apportioned resource units for sensing” mode, and a “balanced priority” mode. According to the “global priority to data” mode, priority may be given to any data that is queued to be sent. Accordingly, whilst there is data to be transferred, no sensing transmissions may be made and a basic trigger may be used to trigger the transfer of data in a TXOP. In an example, the basic trigger may utilize the TXOP entirely for data transmissions from one or more stations. According to the “global priority to sensing” mode, priority may be given to any sensing requirements. Accordingly, whilst there are sensing transmissions required in a TXOP (i.e., at a specified time) then no data transmissions may occur, and a UL-OFDMA sensing trigger may be used to trigger the sensing transmissions in a TXOP. In an example, the UL-OFDMA sensing trigger may utilize the TXOP entirely for sensing transmissions from one or more sensing transmitters. According to the “apportioned resource units for sensing” mode, scheduler 516 may secure a portion of the propagation channel bandwidth in a TXOP for allocation of sensing transmissions. In an example, the allocation may depend on whether there is a sensing transmission required from a sensing transmitter in that TXOP. In the example, if the apportioned RUs (or channel resources) cannot be filled by the sensing transmissions, then they may become available again for data transmissions. According to the “balanced priority” mode, priority may be given based on an assessment of priority of transmission calculated and stored by scheduler 516. In an example, data priorities and sensing priorities may be processed as they are stored, and both data priorities and sensing priorities may be considered equal. According to an example, “HIGH” priority data transmissions may be processed before “NONE” priority sensing transmissions, and “MUST” priority sensing transmissions may be processed before “HIGH” priority data transmissions and “NONE” priority sensing transmissions are processed.

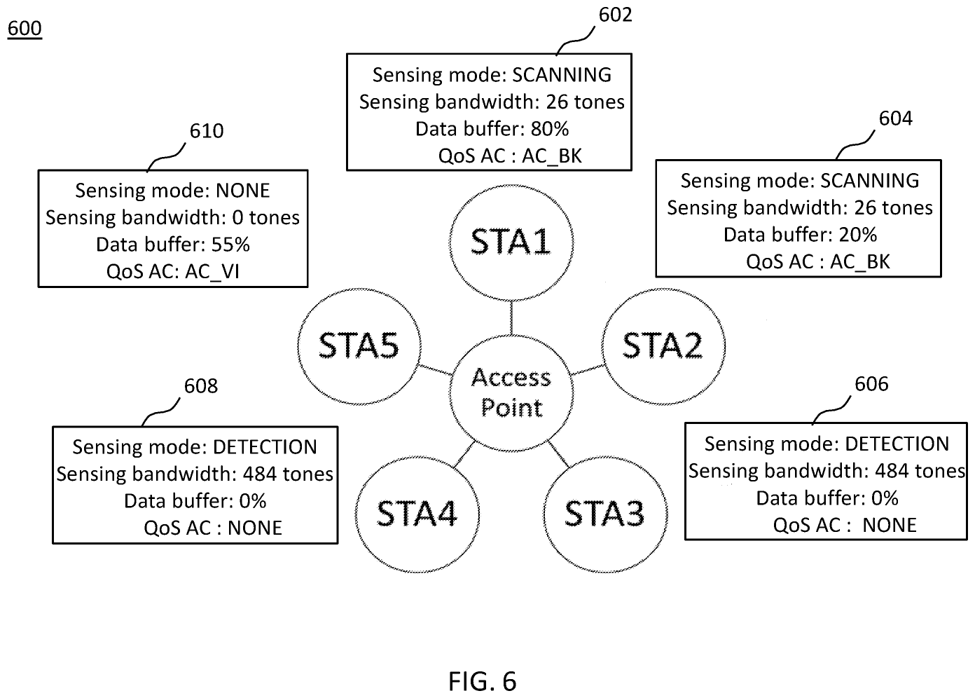

FIG. 6 depicts example 600 of sensing requirements and data requirements for a network of an access point and a number of stations, according to some embodiments.

In the example of FIG. 6, an access point and five stations, namely STA1, STA2, STA3, STA4, and STA5 are shown. In an example, the access point may be sensing receiver 502 and the five stations may each be one of sensing transmitters 504-(1-M) or stations 506-(1-N). As described in FIG. 6, block 602 represents sensing requirements and data requirements of STA1. In an example, for STA1, sensing mode is scanning mode, sensing bandwidth is 26 tones, data buffer is 80 percent, and QoS AC is AC_BK. Block 604 represents sensing requirements and data requirements of STA2. In an example, for STA2, sensing mode is scanning mode, sensing bandwidth is 26 tones, data buffer is 20 percent, and QoS AC is AC_BK. Block 606 represents sensing requirements and data requirements of STA3. In an example, for STA3, sensing mode is detection mode, sensing bandwidth is 484 tones, data buffer is 0 (zero) percent, and QoS AC is none. Block 608 represents sensing requirements and data requirements of STA4. In an example, for STA4, sensing mode is detection mode, sensing bandwidth is 484 tones, data buffer is 0 (zero) percent, and QoS AC is none. Block 610 represents sensing requirements and data requirements of STA5. In an example, for STA5, sensing mode is none, sensing bandwidth is 0 (zero) tones, data buffer is 55 percent, and QoS AC is AC_VI none. According to an implementation, when a station makes a sensing transmission, it may be referred to as a sensing transmitter.

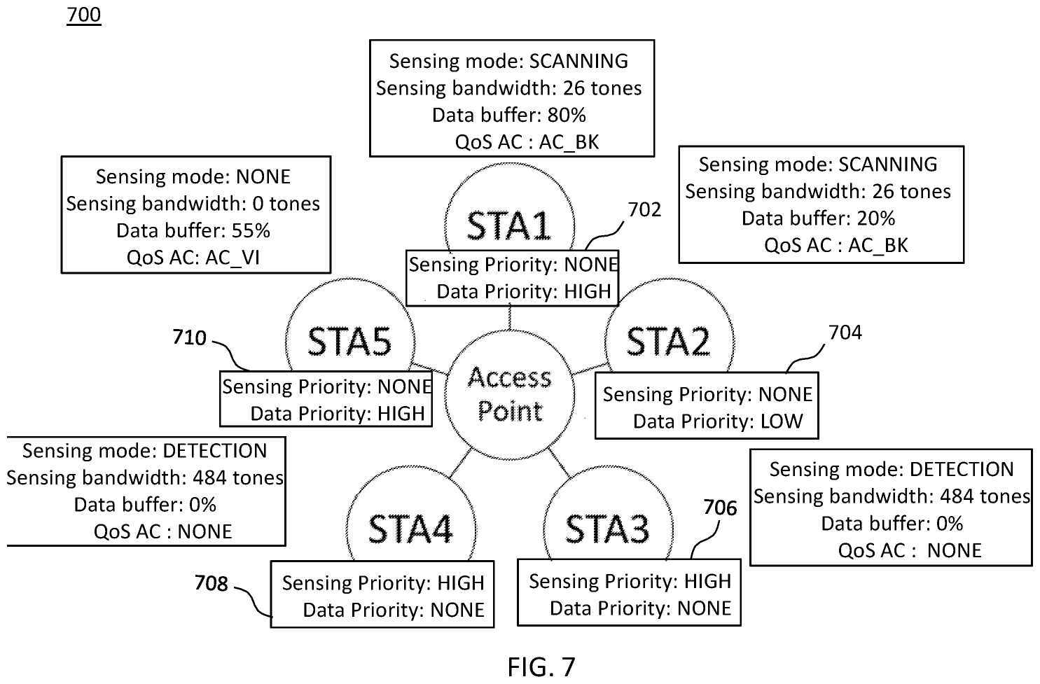

FIG. 7 depicts example 700 of prioritization for a network of an access point and a number of stations based on sensing requirements and data requirements, according to some embodiments.

In the example of FIG. 7, an access point and five stations, namely STA1, STA2, STA3, STA4, and STA5 are shown. In an example, the access point may be sensing receiver 502 and the five stations may each be one of sensing transmitters 504-(1-M) or stations 506-(1-N). In an implementation, the access point may determine sensing priorities and data priorities of STA1, STA2, STA3, STA4, and STA5 based on sensing requirements and data requirements of STA1, STA2, STA3, STA4, and STA5.

As described in FIG. 7, block 702 represents a sensing priority and a data priority of STA1. In the example shown in FIG. 7, the sensing priority of STA1 is “NONE,” and the data priority of STA1 is “HIGH.” Block 704 represents a sensing priority and a data priority of STA2. In an example, the sensing priority of STA2 is “NONE,” and the data priority of STA2 is “LOW.” Block 706 represents a sensing priority and a data priority of STA3. In an example, the sensing priority of STA3 is “HIGH,” and the data priority of STA4 is “NONE.” Block 708 represents a sensing priority and a data priority of STA4. In an example, the sensing priority of STA4 is “HIGH,” and the data priority of STA4 is “NONE.” Block 710 represents a sensing priority and a data priority of STA5. In an example, the sensing priority of STA5 is “NONE,” and the data priority of STA5 is “HIGH.”

Referring again to FIG. 5, in an implementation, scheduler 516 may allocate a first sensing channel resource allocation to first sensing transmitter 504-1, a second sensing channel resource allocation to second sensing transmitter 504-2, a first data channel resource allocation to first station 506-1, and a second data channel resource allocation to second station 506-2. In an implementation, scheduler 516 may determine the first sensing channel resource allocation, the second sensing channel resource allocation, the first data channel resource allocation, and the second data channel resource allocation according to the first sensing requirement and the first sensing priority of first sensing transmitter 504-1, the second sensing requirement and the second sensing priority of second sensing transmitter 504-2, the first data requirement and the first data priority of first station 506-1, and the second data requirement and the second data priority of second station 506-2, respectively. In an implementation, scheduler 516 may determine the first sensing channel resource allocation, the second sensing channel resource allocation, the first data channel resource allocation, and the second data channel resource allocation to maximize resource usage. In an example implementation, at least one of the first sensing channel resource allocation and the second sensing channel resource allocation may include a plurality of carrier tones from a OFDM modulation scheme. According to an implementation, scheduler 516 may determine the first sensing channel resource allocation, the second sensing channel resource allocation, the first data channel resource allocation, and the second data channel resource allocation according to a pre-allocated split between data transmission and sensing bandwidth. In an example, some pending or queued data transmissions may be made in the TXOP and some data transmissions may be held until a next TXOP.

In an implementation, scheduler 516 may reserve a portion of uplink bandwidth in the TXOP for sensing transmissions in a scanning mode. In an example implementation, scheduler 516 may allocate a small RU assignment to one of first sensing transmitter 504-1 and second sensing transmitter 504-2 for low resolution detection of motion or movement in a sensing space. In some implementations, scheduler 516 may reserve a portion of UL bandwidth in the TXOP for sensing transmissions in a detection mode. In some example implementation, scheduler 516 may allocate larger RU assignments to one of first sensing transmitter 504-1 and second sensing transmitter 504-2 for high resolution detection of motion or movement in a sensing space. Accordingly, one of first sensing transmitter 504-1 and second sensing transmitter 504-2 operating in scanning mode and one of first sensing transmitter 504-1 and second sensing transmitter 504-2 operating in detection mode may be allocated uplink bandwidth in the TXOP for sensing transmissions, where the total uplink bandwidth allocated for sensing transmissions in the TXOP is the bandwidth that is not required for uplink data transmission in the same TXOP.

According to an implementation, when it is determined that a combination of data transmissions and sensing transmissions are required in the TXOP, generation unit 518 may create a hybrid sensing-data trigger. In an example, the hybrid sensing-data trigger may initialize the sensing transmissions and the data transmissions. In an implementation, the hybrid sensing-data trigger may notify first sensing transmitter 504-1, second sensing transmitter 504-2, first station 506-1, and second station 506-2 of their allocation of channel resources (or RUs) within the uplink bandwidth for use in the TXOP.

In an implementation, the hybrid sensing-data trigger may include resource allocation fields corresponding to each of the first sensing channel resource allocation to first sensing transmitter 504-1, the second sensing channel resource allocation to second sensing transmitter 504-2, the first data channel resource allocation to first station 506-1, and the second data channel resource allocation to second station 506-2. According to some implementations, the hybrid sensing-data trigger may include a first requested transmission configuration field corresponding to the first sensing requirement and a second requested transmission configuration field corresponding to the second sensing requirement. According to an implementation, the hybrid sensing-data trigger may include transmission parameters for a resulting sensing transmission using a requested transmission configuration field. In an implementation, the hybrid sensing-data trigger may instruct at least one of first sensing transmitter 504-1 and second sensing transmitter 504-2, and at least one of first station 506-1 and second station 506-2 to make a sensing transmission and a data transmission, respectively, using UL-OFDMA.

According to an implementation, example 800 of hierarchy of fields within the hybrid sensing-data trigger is shown in FIGS. 8A to 8H. In an example, a new trigger type (within B0 . . . 3 of “Common Info” field) is defined which represents the hybrid sensing-data trigger. The hybrid sensing-data trigger may include the “Common Info” field, a “User Info List” field, and various other fields.

As described in FIG. 8B, the hybrid sensing-data trigger may have a subfield value of 9. The hybrid sensing-data trigger may combine a trigger frame format with multiple sensing trigger messages (for example, up to one sensing trigger message per sensing transmitter which is being triggered into making a sensing transmission). Since the hybrid sensing-data trigger triggers at least one of first sensing transmitter 504-1 and second sensing transmitter 504-2 to make the sensing transmission and at least one of first station 506-1 and second station 506-2 to make a data transmission, the “User Info list” field may indicate which type of uplink response is being triggered and parameters that at least one of first sensing transmitter 504-1 and second sensing transmitter 504-2, and at least one of first station 506-1 and second station 506-2 may be instructed to use. In an example, RU allocation for at least one of first sensing transmitter 504-1 and second sensing transmitter 504-2, and at least one of first station 506-1 and second station 506-2 may be specified in the “User Info list” field.

In an example of triggering a sensing transmission from a sensing transmitter, “Trigger Dependent User Info” field may include sensing trigger message data. In an example, the sensing trigger message may have a Message Type value of 2 (Sensing Trigger Message). In an example of triggering a data transmission from a station, the hybrid sensing-data trigger may not include any special information and the formatting of a basic Trigger frame (for example, the formatting of the “User Info List” field that is part of the basic Trigger frame) may be used. In the case of the data transmission, “Trigger Dependent User Info” field may include data already defined for a basic Trigger frame type. In an example, the “Trigger Dependent User Info” field may be used to specify transmission parameters for a sensing transmission from each sensing transmitter. For example, the “Trigger Dependent User Info” field may include requested transmission configuration, requested timing configuration, and steering matrix configuration to be used by each sensing transmitter when making the sensing transmission.

In an implementation, IEEE 802.11ax defines a basic Trigger frame which allocates bandwidth within a channel to a station participating in the UL-OFDMA frame for data transfer. In an example, the channel may be 20 MHz, 40 MHz, 80 MHz, or 160 MHz in bandwidth. IEEE 802.11ax also introduces a reduction in the spacing between orthogonal subcarriers in a channel resulting in 242 subcarriers in a 20 MHz channel, 484 subcarriers in a 40 MHz channel, and 996 subcarriers in a 160 MHz channel. This mode of operation allows scheduler 516 greater control of the multiplexing of multiple stations in a TXOP and allows finer allocation of data bandwidth and more efficient usage of the propagation channel for carrying data.

Referring again to FIG. 5, in an implementation, generation unit 518 may transmit the hybrid sensing-data trigger to first sensing transmitter 504-1, second sensing transmitter 504-2, first station 506-1, and second station 506-2. According to an implementation, generation unit 518 may transmit, via transmitting antenna 512, the hybrid sensing-data trigger to first sensing transmitter 504-1, second sensing transmitter 504-2, first station 506-1, and second station 506-2. In an example implementation, the hybrid sensing-data trigger may be configured to cause transmission of a first sensing transmission from first sensing transmitter 504-1 according to the first sensing channel resource allocation, transmission of a second sensing transmission from second sensing transmitter 504-2 according to the second sensing channel resource allocation, transmission of a first data transmission from first station 506-1 according to the first data channel resource allocation, and transmission of a second data transmission from second station 506-2 according to the second data channel resource allocation. In an example implementation, generation unit 518 may transmit the hybrid sensing-data trigger to first sensing transmitter 504-1, second sensing transmitter 504-2, first station 506-1, and second station 506-2 using a broadcast message.

In response to the hybrid sensing-data trigger, first sensing transmitter 504-1 may generate the first sensing transmission, second sensing transmitter 504-2 may generate the second sensing transmission, first station 506-1 may generate the first data transmission, and second station 506-2 may generate the second data transmission. In an example, a sensing transmission from a sensing transmitter may be a sensing response message. According to an implementation, first sensing transmitter 504-1, second sensing transmitter 504-2, first station 506-1, and second station 506-2 may transmit the first sensing transmission, the second sensing transmission, the first data transmission, and the second data transmission, respectively, to sensing receiver 502.

In an implementation, sensing receiver 502 may receive, via receiving antenna 514, a response to the hybrid sensing-data trigger. In an example implementation, sensing receiver 502 may receive the response to the hybrid sensing-data trigger within one SIFS. In an example, the duration of SIFS may be 10 μs. According to an implementation, sensing receiver 502 may receive, via receiving antenna 514, the first sensing transmission from first sensing transmitter 504-1, the second sensing transmission from second sensing transmitter 504-2, the first data transmission from first station 506-1, and the second data transmission from second station 506-2. Subsequently, generation unit 518 may analyze and process the first data transmission and the second data transmission to determine data transfer goals of first station 506-1 and second station 506-2. Further, generation unit 518 may process the first sensing transmission and the second sensing transmission to generate a series of sensing measurements. In an implementation, generation unit 518 may generate a first sensing measurement based on the first sensing transmission and a second sensing measurement based on the second sensing transmission.

According to an implementation, generation unit 518 may generate a first time stamp indicating a time that the first sensing transmission from first sensing transmitter 504-1 was received by sensing receiver 502. In an implementation, sensing receiver 502 and first sensing transmitter 504-1 may form a part of a BSS. According to an IEEE 802.11 standard, a TSF (Timing Synchronization Function) Timer (also referred to as a system clock) of each individual device within the BSS is synchronized to within a predefined tolerance value using the TSF along with synchronizing beacon frames. In an example, the predefined tolerance value is ±100 ppm. In an implementation, a value of the TSF Timer of sensing receiver 502 and first sensing transmitter 504-1 may be identical to within the predefined tolerance value of the TSF. According to an example, the value of the TSF Timer may be associated with a reference time in real-time, such as Coordinated Universal Time (UTC), Global Positioning System (GPS) time, or a network time derived from a Network Time Protocol (NTP) server.

In an implementation, generation unit 518 may generate a first time stamp to be associated with the first sensing transmission. In an example, generation unit 518 may generate the first time stamp according to a timing indication indicating when the first sensing transmission was valid from the time value of the TSF Timer. Other examples of generation of the time stamp that are not discussed are contemplated herein. In a similar manner as described above, generation unit 518 may generate a second time stamp to be associated with the second sensing transmission.

According to an implementation, prioritization of sensing transmissions and data transmissions determined by scheduler 516 may result in sensing measurements which are time-sensitive i.e., being made at a time which is not expected or otherwise not known accurately (such an inaccuracy in timing may be known as measurement time jitter). In such scenario, generation unit 518 may apply the first time stamp and the second time stamp to the first sensing transmission (or the first sensing measurement) and the second sensing transmission (or the second sensing measurement), respectively. In example, a correction is made in sensing receiver 502 for the propagation delay. In an example, the first time stamp and the second time stamp may be synchronized to a UTC reference. In some examples, the first time stamp and the second time stamp may compensate for delays in sensing receiver 502 and be referred to a particular point in a receive chain of sensing receiver 502 (for example, at receiving antenna 514). According to an implementation, system 500 may be enabled to compensate/remove measurement time jitter which may affect the interpretation of the first sensing measurement and the second sensing measurement in making sensing goals (such as detecting presence, motions, and/or movements) and the application of the first time stamp and the second time stamp to the first sensing transmission and the second sensing transmission may allow much greater flexibility of variation of the time of the first sensing transmission and the second sensing transmission.

In some implementations, generation unit 518 may transmit the first sensing measurement and the second sensing measurement along with the first time stamp and the second time stamp to remote processing device 530. On receiving the first sensing measurement and the second sensing measurement, remote processing device 530 may execute a sensing algorithm to detect presence, motions, and/or movements.

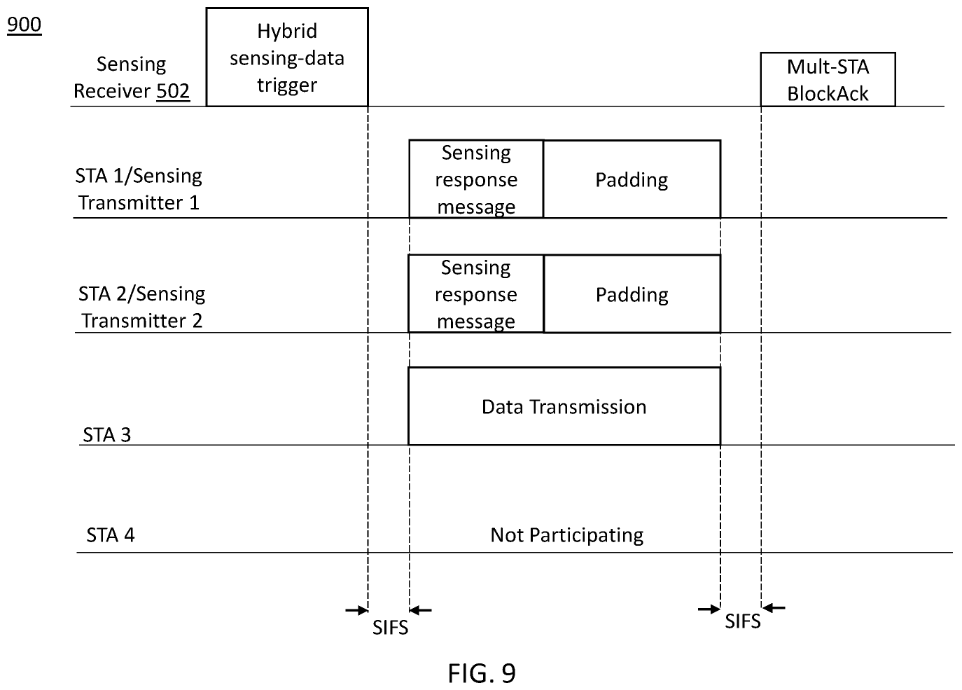

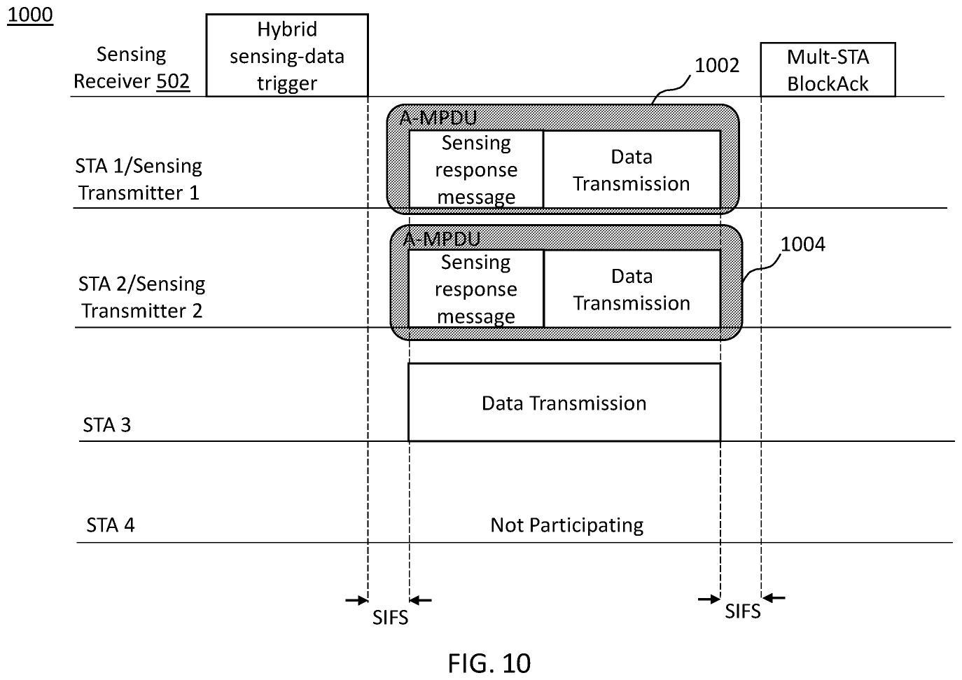

An example of an UL-OFDMA based sensing and data transmissions transaction 900 is shown in FIG. 9 and an example of an UL-OFDMA based sensing and data transmissions transaction 1000 using Aggregated MAC Protocol Data Unit (A-MPDU) is shown in FIG. 10.

In the example shown in FIG. 9, sensing receiver 502 is a sensing initiator and transmits a hybrid sensing-data trigger to trigger sensing transmissions from sensing transmitter 1 and sensing transmitter 2, and a data transmission from STA 3. In response to the hybrid sensing-data trigger, each of the sensing transmitter 1 and the sensing transmitter 2 transmits a sensing transmission (for example, a sensing response message), and STA 3 transmits a data transmission. As can be seen in FIG. 9, the sensing transmission and/or the data transmission follows the hybrid sensing-data trigger after one SIFS. In an example, the duration of SIFS is 10 μs. In an implementation, sensing receiver 502 may acknowledge the responses from the sensing transmitter 1, the sensing transmitter 2, and the STA. In an example implementation, sensing receiver 502 may transmit a Multi-STA BlockAck to the sensing transmitter 1, the sensing transmitter 2, and the STA.

According to an implementation, sensing receiver 502 may determine that there is a sensing requirement and a data requirement that are both satisfied by aggregating a sensing transmission with a data transmission. In an example implementation, the sensing transmission may be aggregated with the data transmission using aggregated MPDU (A-MPDU). In the example shown in FIG. 10, at block 1002, sensing response message (sensing transmission) and data transmission are received from a device acting as the STA1 and sensing transmitter 1. At block 1004, sensing response message (sensing transmission) and data transmission are received from another device acting as STA2 and sensing transmitter 2.

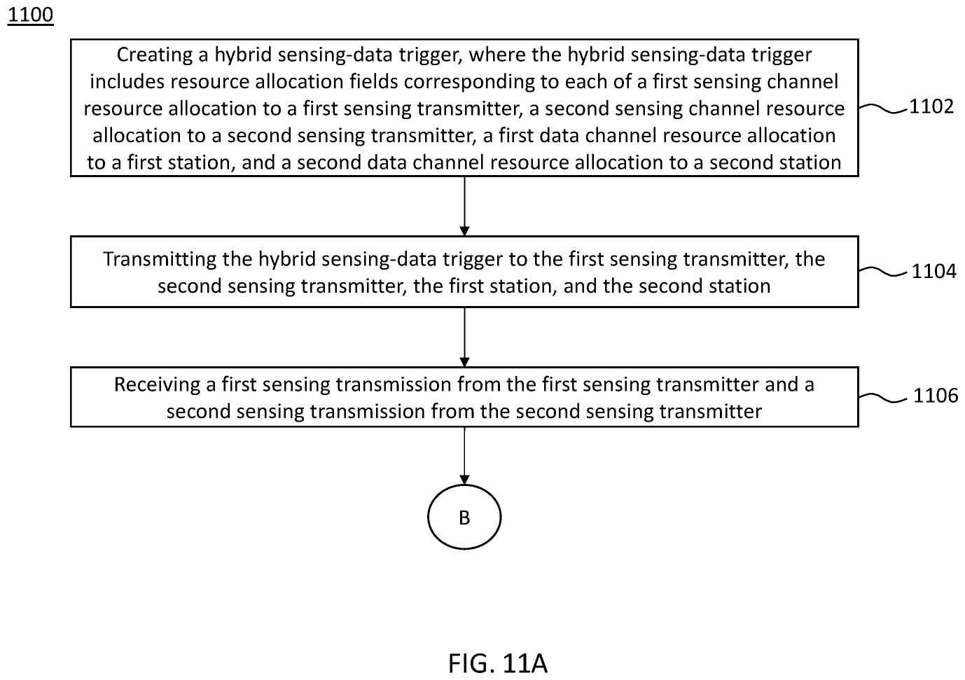

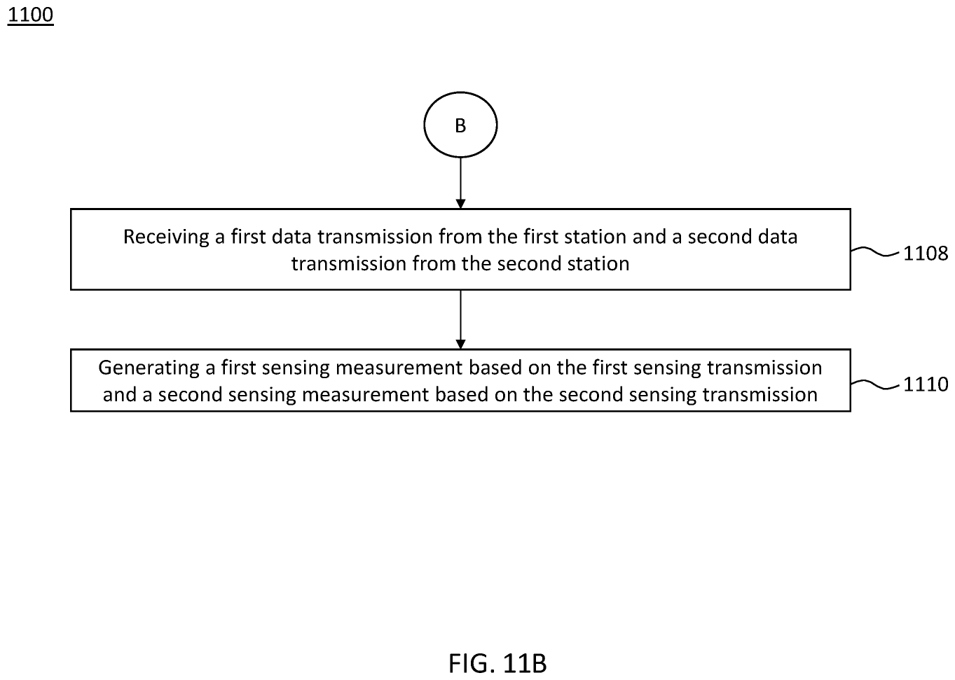

FIGS. 11A and 11B depict flowchart 1100 for generating sensing measurements based on sensing transmissions, according to some embodiments.

In brief over of an implementation of flowchart 1100, at step 1102, a hybrid sensing-data trigger is created. The hybrid sensing-data trigger includes resource allocation fields corresponding to each of a first sensing channel resource allocation to first sensing transmitter 504-1, a second sensing channel resource allocation to second sensing transmitter 504-2, a first data channel resource allocation to first station 506-1, and a second data channel resource allocation to second station 506-2. At step 1104, the hybrid sensing-data trigger is transmitted to first sensing transmitter 504-1, second sensing transmitter 504-2, first station 506-1, and second station 506-2. At step 1106, a first sensing transmission is received from first sensing transmitter 504-1 and a second sensing transmission is received from second sensing transmitter 504-2. At step 1108, a first data transmission is received from first station 506-1 and a second data transmission is received from second station 506-2. At step 1110, a first sensing measurement is generated based on the first sensing transmission and a second sensing measurement is generated based on the second sensing transmission.

Step 1102 includes creating a hybrid sensing-data trigger. The hybrid sensing-data trigger includes resource allocation fields corresponding to each of a first sensing channel resource allocation to first sensing transmitter 504-1, a second sensing channel resource allocation to second sensing transmitter 504-2, a first data channel resource allocation to first station 506-1, and a second data channel resource allocation to second station 506-2. According to an implementation, sensing receiver 502 may create the hybrid sensing-data trigger including resource allocation fields corresponding to each of the first sensing channel resource allocation to first sensing transmitter 504-1, the second sensing channel resource allocation to second sensing transmitter 504-2, the first data channel resource allocation to first station 506-1, and the second data channel resource allocation to second station 506-2. In an example, at least one of the first sensing channel resource allocation and the second sensing channel resource allocation may include a plurality of carrier tones from a OFDM modulation scheme. In some implementations, the hybrid sensing-data trigger may include a first requested transmission configuration field corresponding to the first sensing requirement and a second requested transmission configuration field corresponding to the second sensing requirement. In an implementation, the hybrid sensing-data trigger may be configured to cause transmission of the first sensing transmission from first sensing transmitter 504-1 according to the first sensing channel resource allocation, transmission of the second sensing transmission from second sensing transmitter 504-2 according to the second sensing channel resource allocation, transmission of the first data transmission from first station 506-1 according to the first data channel resource allocation, and transmission of the second data transmission from second station 506-2 according to the second data channel resource allocation.

Step 1104 includes transmitting the hybrid sensing-data trigger to first sensing transmitter 504-1, second sensing transmitter 504-2, first station 506-1, and second station 506-2. According to an implementation, sensing receiver 502 may transmit the hybrid sensing-data trigger to first sensing transmitter 504-1, second sensing transmitter 504-2, first station 506-1, and second station 506-2. In an example, the hybrid sensing-data trigger is a broadcast message and may be sent to all STA which are part of the BSS. In an examples, all STA which are part of the BSS includes first sensing transmitter 504-1, second sensing transmitter 504-2, first station 506-1, and second station 506-2.

Step 1106 includes receiving a first sensing transmission from first sensing transmitter 504-1 and a second sensing transmission from second sensing transmitter 504-2. According to an implementation, sensing receiver 502 may receive the first sensing transmission from first sensing transmitter 504-1 and the second sensing transmission from second sensing transmitter 504-2

Step 1108 includes receiving a first data transmission from first station 506-1 and a second data transmission from second station 506-2. According to an implementation, sensing receiver 502 may receive the first data transmission from first station 506-1 and the second data transmission from second station 506-2. In an implementation, the first sensing transmission and the first data transmission may be received from a first device acting as first sensing transmitter 504-1 and first station 506-1. Likewise, the second sensing transmission and the second data transmission may be received from a second device acting as second sensing transmitter 504-2 and second station 506-2.

Step 1110 includes generating a first sensing measurement based on the first sensing transmission and a second sensing measurement based on the second sensing transmission. According to an implementation, sensing receiver 502 may generate the first sensing measurement based on the first sensing transmission and the second sensing measurement based on the second sensing transmission. In an implementation, sensing receiver 502 may generate a first time stamp indicating a time that the first sensing transmission was received by sensing receiver 502 and a second time stamp indicating a time that the second sensing transmission was received by sensing receiver 502.

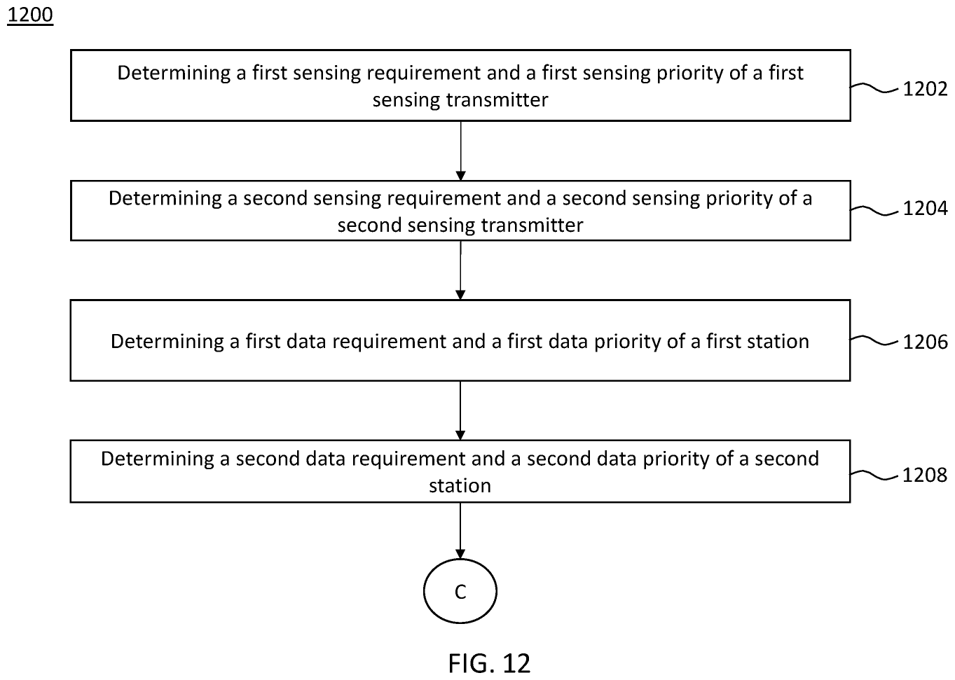

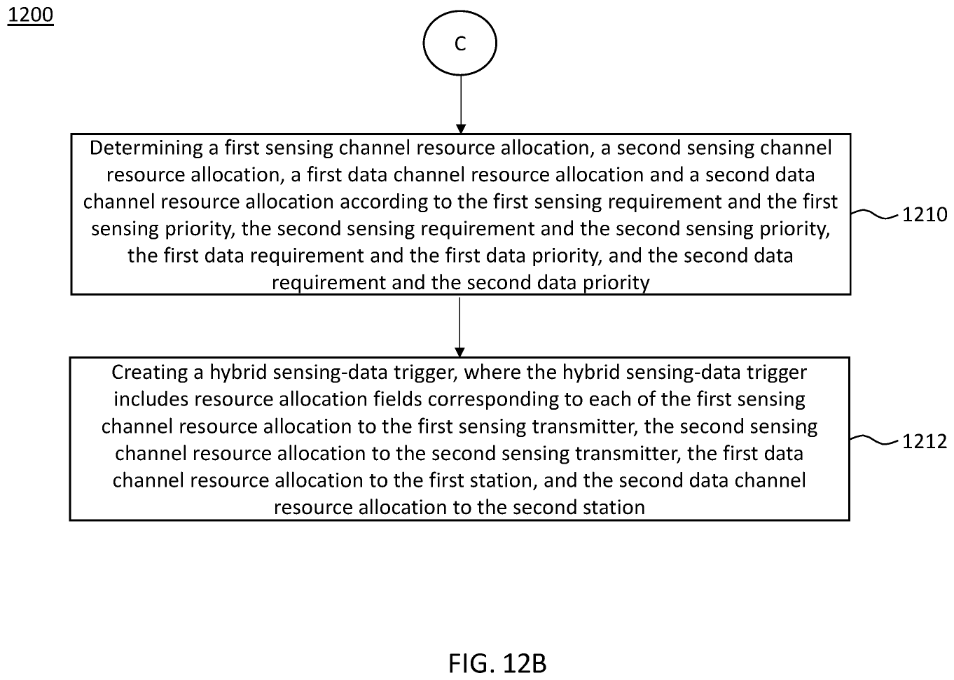

FIGS. 12A and 12B depict flowchart 1200 for creating a hybrid sensing-data trigger, according to some embodiments.

In brief over of an implementation of flowchart 1200, at step 1202, a first sensing requirement and a first sensing priority of first sensing transmitter 504-1 are determined. At step 1204, a second sensing requirement and a second sensing priority of second sensing transmitter 504-2 are determined. At step 1206, a first data requirement and a first data priority of first station 506-1 are determined. At step 1208, a second data requirement and a second data priority of second station 506-2 are determined. At step 1210, a first sensing channel resource allocation, a second sensing channel resource allocation, a first data channel resource allocation and a second data channel resource allocation are determined according to the first sensing requirement and the first sensing priority, the second sensing requirement and the second sensing priority, the first data requirement and the first data priority, and the second data requirement and the second data priority. At step 1212, a hybrid sensing-data trigger is created. The hybrid sensing-data trigger includes resource allocation fields corresponding to each of the first sensing channel resource allocation to first sensing transmitter 504-1, the second sensing channel resource allocation to second sensing transmitter 504-2, the first data channel resource allocation to first station 506-1, and the second data channel resource allocation to second station 506-2.

Step 1202 includes determining a first sensing requirement and a first sensing priority of first sensing transmitter 504-1. According to an implementation, sensing receiver 502 may determine the first sensing requirement and the first sensing priority of first sensing transmitter 504-1.

Step 1204 includes determining a second sensing requirement and a second sensing priority of second sensing transmitter 504-2. According to an implementation, sensing receiver 502 may determine the second sensing requirement and the second sensing priority of second sensing transmitter 504-2. In an implementation, the first sensing requirement and the first sensing priority and the second sensing requirement and the second priority may be determined based on a first sensing mode of first sensing transmitter 504-1 and a second sensing mode of second sensing transmitter 504-2. In an example, at least one of the first sensing mode and the second sensing mode may be a scanning mode. In some examples, at least one of the first sensing mode and the second sensing mode may be a detection mode. According to some implementations, at least one of the first sensing requirement and the first sensing priority, and the second sensing requirement and the second sensing priority may be determined based on a total number of sensing transmitters.

Step 1206 includes determining a first data requirement and a first data priority of first station 506-1. According to an implementation, sensing receiver 502 may determine the first data requirement and the first data priority of first station 506-1.

Step 1208 includes determining a second data requirement and a second data priority of second station 506-2. According to an implementation, sensing receiver 502 may determine the second data requirement and the second data priority of second station 506-2. In an example implementation, the first data requirement and the first data priority and the second data requirement and the second data priority may be determined based on a first measure of fullness of a first transmission data buffer and a second measure of fullness of a second transmission data buffer. In an implementation, the first measure of fullness may be received by sensing receiver 504 from first station 506-1 and the second measure of fullness may be received by sensing receiver from second station 506-2. In some implementations, the first measure of fullness may be received by sensing receiver 502 in response to a request sent to first station 506-1 and the second measure of fullness may be received by sensing receiver 502 in response to a request sent to second station 506-2. According to an implementation, the first data requirement and the first data priority and the second data requirement and the second data priority may be determined based on a quality of service (QOS) access category (AC) of the first transmission data buffer and a QOS AC of the second transmission data buffer.

Step 1210 includes determining a first sensing channel resource allocation, a second sensing channel resource allocation, a first data channel resource allocation and a second data channel resource allocation according to the first sensing requirement and the first sensing priority, the second sensing requirement and the second sensing priority, the first data requirement and the first data priority, and the second data requirement and the second data priority. According to an implementation, sensing receiver 502 may determine the first sensing channel resource allocation, the second sensing channel resource allocation, the first data channel resource allocation, and the second data channel resource allocation according to the first sensing requirement and the first sensing priority, the second sensing requirement and the second sensing priority, the first data requirement and the first data priority, and the second data requirement and the second data priority. In an example, at least one of the first sensing channel resource allocation and the second sensing channel resource allocation may include a plurality of carrier tones from a OFDM modulation scheme. According to an implementation, the first sensing channel resource allocation, the second sensing channel resource allocation, the first data channel resource allocation, and the second data channel resource allocation may be determined according to a pre-allocated split between data transmission and sensing bandwidth. In some implementations, the first sensing channel resource allocation, the second sensing channel resource allocation, the first data channel resource allocation, and the second data channel resource allocation may be determined to maximize resource usage.

Step 1212 includes creating a hybrid sensing-data trigger. The hybrid sensing-data trigger includes resource allocation fields corresponding to each of the first sensing channel resource allocation to first sensing transmitter 504-1, the second sensing channel resource allocation to second sensing transmitter 504-2, the first data channel resource allocation to first station 506-1, and the second data channel resource allocation to second station 506-2. According to an implementation, sensing receiver 502 may create the hybrid sensing-data trigger including resource allocation fields corresponding to each of the first sensing channel resource allocation to first sensing transmitter 504-1, the second sensing channel resource allocation to second sensing transmitter 504-2, the first data channel resource allocation to first station 506-1, and the second data channel resource allocation to second station 506-2.

Embodiment 1 is a method for Wi-Fi sensing carried out by a sensing receiver including a transmitting antenna, a receiving antenna, and at least one processor configured to execute instructions, the method comprising: creating a hybrid sensing-data trigger, wherein the hybrid sensing-data trigger comprises resource allocation fields corresponding to each of: a first sensing channel resource allocation to a first sensing transmitter; a second sensing channel resource allocation to a second sensing transmitter; a first data channel resource allocation to a first station; and a second data channel resource allocation to a second station, transmitting, via the transmitting antenna, the hybrid sensing-data trigger to the first sensing transmitter, the second sensing transmitter, the first station, and the second station; receiving, via the receiving antenna, a first sensing transmission from the first sensing transmitter and a second sensing transmission from the second sensing transmitter; receiving, via the receiving antenna, a first data transmission from the first station and a second data transmission from the second station; and generating, by the at least one processor, a first sensing measurement based on the first sensing transmission and a second sensing measurement based on the second sensing transmission.

Embodiment 2 is the method of embodiment 1, further comprising determining, by the at least one processor, a first sensing requirement and a first sensing priority of the first sensing transmitter; determining, by the at least one processor, a second sensing requirement and a second sensing priority of the second sensing transmitter; determining, by the at least one processor, a first data requirement and a first data priority of the first station; and determining, by the at least one processor, a second data requirement and a second data priority of the second station, wherein the first sensing channel resource allocation, the second sensing channel resource allocation, the first data channel resource allocation and the second data channel resource allocation are determined according to the first sensing requirement and the first sensing priority, the second sensing requirement and the second sensing priority, the first data requirement and the first data priority, and the second data requirement and the second data priority.

Embodiment 3 is the method of embodiment 1 or 2, wherein at least one of the first sensing channel resource allocation and the second sensing channel resource allocation comprises a plurality of carrier tones from a OFDM modulation scheme.

Embodiment 4 is the method of embodiment 2 or 3, wherein determining the first data requirement and the first data priority and the second data requirement and the second data priority is based on a first measure of fullness of a first transmission data buffer and a second measure of fullness of a second transmission data buffer.

Embodiment 5 is the method of embodiment 4, where the first measure of fullness is received by the sensing receiver from the first station.

Embodiment 6 is the method of embodiment 5, where the first measure of fullness is received by the sensing receiver in response to a request sent to the first station.

Embodiment 7 is the method of any of embodiments 2-6, wherein determining the first data requirement and the first data priority and the second data requirement and the second data priority is based on a quality of service access category of the first transmission data buffer and a quality of service access category of the second transmission data buffer.

Embodiment 8 is the method of any of embodiments 2-7, wherein determining the first sensing requirement and the first sensing priority and the second sensing requirement and the second priority is based on a first sensing mode of the first sensing transmitter and a second sensing mode of the second sensing transmitter.

Embodiment 9 is the method of embodiment 8, wherein at least one of the first sensing mode and the second sensing mode is a scanning mode.

Embodiment 10 is the method of embodiment 8 or 9, wherein at least one of the first sensing mode and the second sensing mode is a detection mode.

Embodiment 11 is the method of any of embodiments 2-10, wherein determining at least one of the first sensing requirement and the first sensing priority, and the second sensing requirement and the second sensing priority is based on a total number of sensing transmitters.

Embodiment 12 is the method of any of embodiments 1-11, wherein the first sensing channel resource allocation, the second sensing channel resource allocation, the first data channel resource allocation and the second data channel resource allocation are determined according to a pre-allocated split between data transmission and sensing bandwidth.

Embodiment 13 is the method of any of embodiments 1-12, wherein the first sensing channel resource allocation, the second sensing channel resource allocation, the first data channel resource allocation and the second data channel resource allocation are determined to maximize resource usage.

Embodiment 14 is the method of any of embodiments 1-13, wherein the hybrid sensing-data trigger comprises a first requested transmission configuration field corresponding to the first sensing requirement and a second requested transmission configuration field corresponding to the second sensing requirement.

Embodiment 15 is the method of any of embodiments 1-14, wherein generating the first sensing measurement based on the first sensing transmission includes the generation of a first time stamp indicating a time that the first sensing transmission was received by the sensing receiver.

Embodiment 16 is the method of any of embodiments 1-15, wherein the hybrid sensing-data trigger is configured to cause: transmission of the first sensing transmission from the first sensing transmitter according to the first sensing channel resource allocation; transmission of the second sensing transmission from the second sensing transmitter according to the second sensing channel resource allocation; transmission of the first data transmission from the first station according to the first data channel resource allocation; and transmission of the second data transmission from the second station according to the second data channel resource allocation.

Embodiment 17 is the method of any of embodiments 1-16, wherein the first sensing transmission and the first data transmission are received from a first device acting as the first sensing transmitter and the first station.

Embodiment 18 is a system for Wi-Fi sensing, the system comprising: a sensing receiver including a transmitting antenna, a receiving antenna, and at least one processor configured to execute instructions for: creating a hybrid sensing-data trigger, wherein the hybrid sensing-data trigger comprises resource allocation fields corresponding to each of: a first sensing channel resource allocation to a first sensing transmitter; a second sensing channel resource allocation to a second sensing transmitter; a first data channel resource allocation to a first station; and a second data channel resource allocation to a second station, transmitting, via the transmitting antenna, the hybrid sensing-data trigger to the first sensing transmitter, the second sensing transmitter, the first station, and the second station; receiving, via the receiving antenna, a first sensing transmission from the first sensing transmitter and a second sensing transmission from the second sensing transmitter; receiving, via the receiving antenna, a first data transmission from the first station and a second data transmission from the second station; and generating, by the at least one processor, a first sensing measurement based on the first sensing transmission and a second sensing measurement based on the second sensing transmission.

Embodiment 19 is the system of embodiment 18, further comprising: determining, by the at least one processor, a first sensing requirement and a first sensing priority of the first sensing transmitter; determining, by the at least one processor, a second sensing requirement and a second sensing priority of the second sensing transmitter; determining, by the at least one processor, a first data requirement and a first data priority of the first station; determining, by the at least one processor, a second data requirement and a second data priority of the second station, wherein the first sensing channel resource allocation, the second sensing channel resource allocation, the first data channel resource allocation and the second data channel resource allocation are determined according to the first sensing requirement and the first sensing priority, the second sensing requirement and the second sensing priority, the first data requirement and the first data priority, and the second data requirement and the second data priority.

Embodiment 20 is the system of embodiment 18 or 19, wherein at least one of the first sensing channel resource allocation and the second sensing channel resource allocation comprises a plurality of carrier tones from a OFDM modulation scheme.

Embodiment 21 is the system of embodiment 19 or 20, wherein determining the first data requirement and the first data priority and the second data requirement and the second data priority is based on a first measure of fullness of a first transmission data buffer and a second measure of fullness of a second transmission data buffer.

Embodiment 22 is the system of embodiment 21, where the first measure of fullness is received by the sensing receiver from the first station.

Embodiment 23 is the system of embodiment 22, where the first measure of fullness is received by the sensing receiver in response to a request sent to the first station.

Embodiment 24 is the system of any of embodiments 19-23, wherein determining the first data requirement and the first data priority and the second data requirement and the second data priority is based on a quality of service access category of the first transmission data buffer and a quality of service access category of the second transmission data buffer.

Embodiment 25 is the system of any of embodiments 19-24, wherein determining the first sensing requirement and the first sensing priority and the second sensing requirement and the second priority is based on a first sensing mode of the first sensing transmitter and a second sensing mode of the second sensing transmitter.

Embodiment 26 is the system of embodiment 25, wherein at least one of the first sensing mode and the second sensing mode is a scanning mode.

Embodiment 27 is the system is the system of embodiment 25 or 26, wherein at least one of the first sensing mode and the second sensing mode is a detection mode.

Embodiment 28 is the system of any of embodiments 19-27, wherein determining at least one of the first sensing requirement and the first sensing priority, and the second sensing requirement and the second sensing priority is based on a total number of sensing transmitters.

Embodiment 29 is the system of any of embodiments 18-28, wherein the first sensing channel resource allocation, the second sensing channel resource allocation, the first data channel resource allocation and the second data channel resource allocation are determined according to a pre-allocated split between data transmission and sensing bandwidth.

Embodiment 30 is the system of any of embodiments 18-29, wherein the first sensing channel resource allocation, the second sensing channel resource allocation, the first data channel resource allocation and the second data channel resource allocation are determined to maximize resource usage.

Embodiment 31 is the system of any of embodiments 18-30, wherein the hybrid sensing-data trigger comprises a first requested transmission configuration field corresponding to the first sensing requirement and a second requested transmission configuration field corresponding to the second sensing requirement.

Embodiment 32 is the system of any of embodiments 18-31, wherein generating the first sensing measurement based on the first sensing transmission includes the generation of a first time stamp indicating a time that the first sensing transmission was received by the sensing receiver.

Embodiment 33 is the system of any of embodiments 18-32, wherein the hybrid sensing-data trigger is configured to cause: transmission of the first sensing transmission from the first sensing transmitter according to the first sensing channel resource allocation; transmission of the second sensing transmission from the second sensing transmitter according to the second sensing channel resource allocation; transmission of the first data transmission from the first station according to the first data channel resource allocation; transmission of the second data transmission from the second station according to the second data channel resource allocation.

Embodiment 34 is the system of any of embodiments 18-33, wherein the first sensing transmission and the first data transmission are received from a first device acting as the first sensing transmitter and the first station.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing receiver including a transmitting antenna, a receiving antenna, and at least one processor configured to execute instructions, the method comprising:
creating a hybrid sensing-data trigger, wherein the hybrid sensing-data trigger comprises resource allocation fields corresponding to each of:
a first sensing channel resource allocation to a first sensing transmitter;
a second sensing channel resource allocation to a second sensing transmitter;
a first data channel resource allocation to a first station; and
a second data channel resource allocation to a second station transmitting, via the transmitting antenna, the hybrid sensing-data trigger to the first sensing transmitter, the second sensing transmitter, the first station, and the second station;
receiving, via the receiving antenna, a first sensing transmission from the first sensing transmitter and a second sensing transmission from the second sensing transmitter;
receiving, via the receiving antenna, a first data transmission from the first station and a second data transmission from the second station; and
generating, by the at least one processor, a first sensing measurement based on the first sensing transmission and a second sensing measurement based on the second sensing transmission.

2. The method of claim 1, further comprising:
determining, by the at least one processor, a first sensing requirement and a first sensing priority of the first sensing transmitter;
determining, by the at least one processor, a second sensing requirement and a second sensing priority of the second sensing transmitter;
determining, by the at least one processor, a first data requirement and a first data priority of the first station; and
determining, by the at least one processor, a second data requirement and a second data priority of the second station;
wherein the first sensing channel resource allocation, the second sensing channel resource allocation, the first data channel resource allocation and the second data channel resource allocation are determined according to the first sensing requirement and the first sensing priority,
the second sensing requirement and the second sensing priority, the first data requirement and
the first data priority, and the second data requirement and the second data priority.

3. The method of claim 1, wherein at least one of the first sensing channel resource allocation and the second sensing channel resource allocation comprises a plurality of carrier tones from a OFDM modulation scheme.

4. The method of claim 2, wherein determining the first data requirement and the first data priority and the second data requirement and the second data priority is based on a first measure of fullness of a first transmission data buffer and a second measure of fullness of a second transmission data buffer.

5-6. (canceled)

7. The method of claim 2, wherein determining the first data requirement and the first data priority and the second data requirement and the second data priority is based on a quality of service access category of the first transmission data buffer and a quality of service access category of the second transmission data buffer.

8-10. (canceled)

11. The method of claim 2, wherein determining at least one of the first sensing requirement and the first sensing priority, and the second sensing requirement and the second sensing priority is based on a total number of sensing transmitters.

12. The method of claim 1, wherein the first sensing channel resource allocation, the second sensing channel resource allocation, the first data channel resource allocation and the second data channel resource allocation are determined according to a pre-allocated split between data transmission and sensing bandwidth.

13. The method of claim 1, wherein the first sensing channel resource allocation, the second sensing channel resource allocation, the first data channel resource allocation and the second data channel resource allocation are determined to maximize resource usage.

14-15. (canceled)

16. The method of claim 1, wherein the hybrid sensing-data trigger is configured to cause:
transmission of the first sensing transmission from the first sensing transmitter according to the first sensing channel resource allocation;
transmission of the second sensing transmission from the second sensing transmitter according to the second sensing channel resource allocation;
transmission of the first data transmission from the first station according to the first data channel resource allocation; and
transmission of the second data transmission from the second station according to the second data channel resource allocation.

17. The method of claim 1, wherein the first sensing transmission and the first data transmission are received from a first device acting as the first sensing transmitter and the first station.

18. A system for Wi-Fi sensing, the system comprising:
a sensing receiver including a transmitting antenna, a receiving antenna, and at least one processor configured to execute instructions for:
creating a hybrid sensing-data trigger, wherein the hybrid sensing-data trigger comprises resource allocation fields corresponding to each of:
a first sensing channel resource allocation to a first sensing transmitter;
a second sensing channel resource allocation to a second sensing transmitter;
a first data channel resource allocation to a first station; and
a second data channel resource allocation to a second station transmitting, via the transmitting antenna, the hybrid sensing-data trigger to the first sensing transmitter, the second sensing transmitter, the first station, and the second station;
receiving, via the receiving antenna, a first sensing transmission from the first sensing transmitter and a second sensing transmission from the second sensing transmitter;
receiving, via the receiving antenna, a first data transmission from the first station and a second data transmission from the second station; and
generating, by the at least one processor, a first sensing measurement based on the first sensing transmission and a second sensing measurement based on the second sensing transmission.

19. The system of claim 18, further comprising:
determining, by the at least one processor, a first sensing requirement and a first sensing priority of the first sensing transmitter;
determining, by the at least one processor, a second sensing requirement and a second sensing priority of the second sensing transmitter;
determining, by the at least one processor, a first data requirement and a first data priority of the first station;
determining, by the at least one processor, a second data requirement and a second data priority of the second station,
wherein the first sensing channel resource allocation, the second sensing channel resource allocation, the first data channel resource allocation and the second data channel resource allocation are determined according to the first sensing requirement and the first sensing priority, the second sensing requirement and the second sensing priority, the first data requirement and the first data priority, and the second data requirement and the second data priority.

20. The system of claim 18, wherein at least one of the first sensing channel resource allocation and the second sensing channel resource allocation comprises a plurality of carrier tones from a OFDM modulation scheme.

21. The system of claim 19, wherein determining the first data requirement and the first data priority and the second data requirement and the second data priority is based on a first measure of fullness of a first transmission data buffer and a second measure of fullness of a second transmission data buffer.

22-23. (canceled)

24. The system of claim 19, wherein determining the first data requirement and the first data priority and the second data requirement and the second data priority is based on a quality of service access category of the first transmission data buffer and a quality of service access category of the second transmission data buffer.

25-27. (canceled)

28. The system of claim 19, wherein determining at least one of the first sensing requirement and the first sensing priority, and the second sensing requirement and the second sensing priority is based on a total number of sensing transmitters.

29. The system of claim 18, wherein the first sensing channel resource allocation, the second sensing channel resource allocation, the first data channel resource allocation and the second data channel resource allocation are determined according to a pre-allocated split between data transmission and sensing bandwidth.

30. The system of claim 18, wherein the first sensing channel resource allocation, the second sensing channel resource allocation, the first data channel resource allocation and the second data channel resource allocation are determined to maximize resource usage.

31-32. (canceled)

33. The system of claim 18, wherein the hybrid sensing-data trigger is configured to cause:
transmission of the first sensing transmission from the first sensing transmitter according to the first sensing channel resource allocation;
transmission of the second sensing transmission from the second sensing transmitter according to the second sensing channel resource allocation;
transmission of the first data transmission from the first station according to the first data channel resource allocation;
transmission of the second data transmission from the second station according to the second data channel resource allocation.

34. The system of claim 18, wherein the first sensing transmission and the first data transmission are received from a first device acting as the first sensing transmitter and the first station.
